(19) United States
(12) Patent Application Publication
(10) Pub. No.: US 2004/0174361 A1
(43) Pub. Date: Sep. 9, 2004

(54) Geometric and brightness modeling of images

(76) Inventors: Yosef Yomdin, Rehovot (IL); Yoram Elichai, Ashdod (IL)

Correspondence Address: William H Dippert, Reed Smith, 29th Floor, 599 Lexington Avenue, New York, NY, 10022-7650, US

(21) Appl. No.: 10/483,786

(22) PCT Filed:
(86) PCT No.: PCT/IL02/00563

Related U.S. Application Data
(63) Continuation-in-part of application No. 09/902,643, filed on Jul. 12, 2001.
(63) Continuation-in-part of application No. 09/716,279, filed on Nov. 21, 2000, now Pat. No. 6,760,483.
(60) Provisional application No. 60/239,912, filed on Oct. 13, 2000.

(51) Int. Cl. G06T 11/20; G09G 5/00

(52) U.S. Cl. 345/441; 345/630

(57) ABSTRACT

A method of representing an image, comprising: determining one or more characteristic lines over which the profile of the image changes considerably; and storing, for each of the one or more characteristic lines, one or more cross section profiles including data on the brightness of the line and of one or more background points adjacent the line having a brightness substantially different from the brightness of the line.

### RELATED APPLICATIONS

This application claims the benefit under 119 (e) of U.S. provisional patent applications 60/304,415, 60/310,486, 60/332,051, 60/334,072 and 60/379,415, filed Jul. 12, 2001, Aug. 8, 2001, Nov. 23, 2001, Nov. 30, 2001, and May 13, 2002, respectively. This application is also a continuation-in-part of U.S. patent applications Ser. Nos. 09/716,279 and 09/902,643 filed Nov. 21, 2000 and Jul. 12, 2001, respectively. The disclosures of all of these applications are incorporated herein by reference.

### FIELD OF THE INVENTION

The present invention relates to representation of images, for example for transmission and/or storage.

### BACKGROUND OF THE INVENTION

Content oriented representation of images is well known in the art. Some partial implementations exist, most of them known under the name “vector formats” or “vectorizations”. Vectorization is the representation of a visual image by geometric entities, like vectors, curves and the like. Vectorized images are usually significantly more compact and easier to process than those images represented by conventional techniques, including use of pixels.

There currently are methods that incorporate limited vector formats, such as Macromedia's Flash and Shock Wave, W3C Scaleable Vector Graphics (SVG) and others. However, these vectorization methods provide cartoon-like images and animations and fail to represent high resolution photo realistic images of the real world. This is because only very simple, cartoon-like images allow for a representation by “edge partitions,” not necessarily present in photo realistic images. In fact, high resolution, real world images present such an enormous variety of forms and complexity of visual patterns, that visually accurate vectorization is practically impossible under the existing methods.

Existing methods of image representation, processing and compression, such as DCT transform and the JPEG compression standard, as well as various wavelet transforms and compression schemes, provide compression of realistic images. These image representation methods, however, do not achieve high compression ratios (typically they achieve a compression ratio of about one to ten for high image quality). In addition, there is generally no relation between the representation and the view of the image, such that any processing of the image requires extracting the image from the compressed representation. Current methods of image representation are based on linear transformations of the image to a certain basis, which contains initially the same numbers of elements as the number of pixels in the original image. Subsequent quantization and filtering reduce the number of parameters, but in an unpredictable fashion. Also, visual interpretation of these reduced number of parameters may be quite difficult.

Moreover, because video sequences represent exactly the motion of certain objects and patterns (i.e. geometric transformations of the initial scene), the DCT or the wavelets representations behave in an incoherent and unpredictable manner. Therefore, existing video compression techniques such as MPEG, use JPEG compression for the first frame, while performing the “motion compensation” on a pixel level and not on the compressed data. This results in a reduction in efficiency.

Various types of skeletons are used in computer graphics, and especially in virtual reality applications. Generally, a skeleton of a graphic is formed of a plurality of “bones”, each of which is associated with a structure of the graphic. In order to describe movements, a controller states the movements to be applied to each bone and the associated structures are moved accordingly, by a computer handling the graphic.

Existing skeletons are applied in conjunction with specially constructed geometric-kinematical models of the graphic. Generally, it is the construction of such a model and its association with the realistic picture of the object (gluing texture) that requires the most costly efforts of skilled professionals.

The above mentioned problems, related to the conventional skeletons, make them inapplicable to the 2D animations. Indeed, the necessity to construct an auxiliary kinematical structure, supporting the object motion, pushes skeletons completely into the world of complicated 3D models, like polygonal models.

### SUMMARY OF THE INVENTION

A broad aspect of some embodiments of the invention relates to a high quality compressed format for representing images using geometric and brightness modeling. In an exemplary embodiment of the invention, the format includes representing characteristic lines of a compressed image by one or more color cross sections of the line and representing the remaining portions of the image in another manner, for example by a selected number of background pixels and/or patches, from which the remaining pixels of the image may be derived using interpolation methods and/or other methods. The term patches refers herein to groups of pixels having same or similar color, surrounded by points having very different colors. In an exemplary embodiment of the invention, such patches are generally used for very small points which are not represented properly by background points. Some methods of compressing images into a compressed format are described in the above mentioned U.S. patent applications Ser. Nos. 09/716,279 and 09/902,643. In the present application, this image representation format is referred to as “Content-Oriented Representation” or “CORE”.

An aspect of some embodiments of the invention relates to a compressed format for representing images using characteristic lines, in which the characteristic lines are represented by cross-section profiles including at least one background parameter, for example a brightness of a background point along the cross section of the characteristic line. The background parameter optionally has a value which differs substantially from an equivalent parameter value of the line itself.

In an exemplary embodiment of the invention, the cross section profiles include three color parameters which describe the color change of the line and two or more color parameters which describe the background adjacent the line. Thus, in some embodiments of the invention, the profile includes more than 25% background parameters. The use of background parameters in the cross sections of the lines potentially reduces the number of background points required and provides a more accurate representation of the compressed images.

Optionally, in compressing an image, in addition to determining the line cross section parameters, the brightness of the background at edges of the cross-section is determined and stored therewith. In some embodiments of the invention, in decompressing, background points are generated along the line, adjacent thereto, with the stored parameter values.

In some embodiments of the invention, the parameters of the images are aggregated along the Characteristic Lines, at the Crossings of characteristic lines in the represented image and/or between the Characteristic Lines and the Background. This may include, for example, storing the Cross-Section parameters of Characteristic Lines at their Crossings, then interpolating them along the Line and using these interpolated data either as the final one or as a prediction. In the last case the actual Cross-Section parameters at the Line Points are optionally given by the corrections to the predicted values. The same procedure can be performed for the Background values at the Crossings and along the lines. Thus, the stability of the image representation is increased and the amount of data required for representation is reduced.

An aspect of some embodiments of the invention relates to a compressed format for representing images using characteristic lines of a plurality of different types with respect to the relation of the lines to the background points. Optionally, the characteristic lines are classified as separating or non-separating lines. Separating lines prevent or reduce the influence of background points included in the compressed format on reconstructed points on the other side of the separating lines. Non-separating lines, however, are optionally considered for the purpose of background construction, as if the lines are non-existent. Alternatively or additionally, one or more partially separating lines are defined, which reduce the influence of points on opposite sides of the line according to their level of separation. Further alternatively or additionally, each characteristic line is associated with a separation level parameter.

In some embodiments of the invention, edges (i.e., lines which are boundaries between two image regions with different colors) are classified as separating lines. Ridges, on the other hand, are optionally classified as either separating or non-separating lines, for example according to the difference between the background color, between the sides of the line. If the background color has a substantial visual difference between the sides of the line, the line is optionally classified as separating, while if the difference is non-substantial or non-existent, the line is optionally classified as non-separating.

In an exemplary embodiment of the invention, in reconstructing a value of a point, the point receives a weighted average of the color values of points specified in the compressed format. The weights optionally depend on the distance between the lines and the separation levels of the lines between the points if such lines exist. Alternatively or additionally, the distance between two points is defined as the shortest path between the points, which does not cross lines having a separation value above a predetermined threshold.

An aspect of some embodiments of the invention relates to a compressed format for representing images using characteristic lines, background points and/or patches, in which at least some of the characteristic lines, background points and/or patches have depth values for three dimensional representations. In some embodiments of the invention, in addition to stating for the points of the characteristic lines their two-dimensional (2D) coordinates, a third coordinate states the depth of the line. Alternatively or additionally, depth is associated with other points along the line. Alternatively or additionally, some or all of the parameters of the line cross-sections are associated with a depth parameter, which represents the depth of the line in the corresponding cross-section point. Optionally, patch center points and/or background points are associated with a depth parameter, in addition to their 2D coordinates. In some embodiments of the invention, points for which a depth is not stated are assumed to have a default (e.g., unit) depth. Alternatively or additionally, points for which a depth is not stated are assumed to have a depth interpolated from depth values stated from neighboring elements, to which a depth was assigned. In some embodiments of the invention, the depth is added to the image by a human operator, optionally using a suitable user interface.

Alternatively or additionally to depth, a different parameter is associated, for example, a rendering parameter such as opacity, reflectivity or material type. Alternatively or additionally, the different parameter is used by a function, for example one provided with the image or with the rendering system for example, such a function can decide a pixel value or a pixel value modification based on the value of the parameter or base don other information such as user input. In one example, this parameter is used to indicate self illuminating points on an image, so when a user changes a general lighting level during display, the intensity of these points is adjusted to compensate for a general reduction in intensity of the image. Alternatively or additionally, the parameter is used as part of a user interface, for example, to indicate a value to be returned if a user selected that point or an area near it.

An aspect of some embodiments of the invention relates to a format of representing the geometry of a characteristic line of an image in a compression format. The format allows using one of a plurality of different segment shapes for representing each of the segments of a characteristic line. In an exemplary embodiment of the invention, the different segment shapes include one or more of parabolic, elliptic and circular. Alternatively or additionally, straight lines and/or other line shapes, such as splines or non-functional shapes, such as freedrawn shapes, are used. Optionally, each segment is represented by the coordinates of its ends, the section shape and the height of its curve above a straight line connecting the ends. Optionally, the use of different segment shapes allows for better fitting of image data by the characteristic lines.

An aspect of some embodiments of the invention relates to a format of representing the geometry of a characteristic line of an image, using elliptic and/or circular shapes. For some image characteristic lines, such as synthetic global circular and elliptic curves which commonly appear in images of animals and humans, visual contours of near-circular, near-spherical or near-ellipsoidal 3D objects, which commonly appear in some handwritten characters, the use of elliptic and/or circular shapes better represents at least some portions of the lines.

In some embodiments of the invention, a human operator may indicate to a compression unit or software, for a specific image and/or for specific lines of an image, which segment shape is to be used. Alternatively or additionally, an image creation software utilized to generate the image assigns to each created line (or to each segment thereof) a line type which is to be used in representing the line.

Further alternatively or additionally, the compression software attempts to fit the line into a plurality of different shapes, and selects the shape which provides the smallest error and/or requires the least representation data. Various error criteria as known in the art, for example, may be used. Optionally, in representing a line, the compression software begins from a first direction attempting to progress each time for a longest segment of the line, without exceeding a predetermined error level. The segment shape which allows for a longest segment is used. This procedure optionally proceeds over the entire line.

An aspect of some embodiments of the invention relates to a method of displaying (or otherwise reconstructing) images represented in a compressed format using geometric and/or brightness modeling, including a plurality of links (e.g., segments of characteristic lines). In an exemplary embodiment of the invention, the method includes opening each link separately, and using for each pixel the value calculated for a single link, optionally the nearest link. The nearest link is optionally determined using a suitable distance function. This method achieves efficient display of the image with a relatively low reduction in quality due to the selection of only a single adjacent link. Alternatively to using only a single link, the values from a plurality of link are merged, for example, by averaging, possible distance weighted. The number of links used may be, for example, all the links, some of the links, the links within a certain distance and/or a fixed number of links.

In some embodiments of the invention, in opening each link, brightness values are determined for a plurality of pixels in the vicinity of the link. Thereafter, for each pixel the value of the closest link is selected. Alternatively, each pixel is first associated with a link, and in opening the links, values are assigned only to pixels associated with the opened link.

In some embodiments of the invention, the distance function uses elliptic equidistant curves at link ends, to provide a correct choice of the link side. This simplifies computations and strongly increases their stability.

An aspect of some embodiments of the invention relates to a method of displaying (or otherwise decompressing) images represented in a compressed format using separating lines and background points. In an exemplary embodiment of the invention, the method includes calculating the distance from a pixel whose value is determined for display, by propagating waves in concentric circles in all directions, until the background points are reached. When a wave hits a separating line it optionally does not continue. Alternatively or additionally, when a wave reaches a partially separating line, the wave is delayed for a number of steps according to the separation level of the line. Alternatively or additionally, other distance calculation or estimation methods are used, for example, non-propagating methods or propagating in a plurality of vector directions (e.g., 4-8) and interpolating between the end points of the vector directions.

An aspect of some embodiments of the invention relates to representing an image by a plurality of layers, at least some of which are represented using contour characteristic lines having cross-section profiles. Dividing an image into a plurality of layers which are represented separately, may allow easier manipulation of the layers of the image, for example for animation. In some embodiments of the invention, one or more objects including a plurality of layers with predetermined relations relative to each other, are defined.

In some embodiments of the invention, the layers are selected by finding image portions which are surrounded entirely by a separating line. Such portions are defined as separate layers. Alternatively or additionally, layers may be defined by a human operator. In some embodiments of the invention, a human operator defines a layer in a first image of a sequence of images and an image compression system finds the layer in other images of the sequence. Optionally, separate layers are defined for objects which are expected to move in an image sequence, such as humans, animals, balls and vehicles.

In some embodiments of the invention, an animation or video set of images includes one or more base images and additional images defined relative to one or more base images. The base images are optionally defined in terms of layers (i.e., sub-textures) formed of characteristic lines with their cross-section profiles, patches and background points. The additional images are optionally defined in terms of motion of objects and/or layers in a three dimensional space and/or color transformations of layers and/or objects. Alternatively or additionally, the additional images are defined in terms of changes in one or more parameters of any the characteristic lines, patches and/or background points relative to the base image. It is noted that since the CORE representation generally follows a visual meaning of the image, the changes between images in a video sequence are generally limited to the geometry of the characteristic lines, patches and/or background points and/or the brightness (color) parameters thereof, without changing the entire representation.

Further alternatively or additionally, the additional images are stated in terms of changes (e.g., movements and/or deformations) in a skeleton associated with image sequence, relative to the form of the skeleton associated with the base image.

An aspect of some embodiments of the invention relates to a method of generating animation based on a two-dimensional image. The method include associating a skeleton with the two-dimensional image, by stating for each of one or more bones (i.e., parts) of the skeleton, the portion of the image to move with the bone. Thereafter, movements are optionally defined for the skeleton, and the portions of the image move relative to each other according to the skeleton movement.

In some embodiments of the invention, the image is cut into a plurality of layers, and each bone of the skeleton is associated with one or more of the layers.

Optionally, at least some of the points of the image are represented by Cartesian coordinates. In some embodiments of the invention, the image and/or its layers are represented as bit maps. Alternatively or additionally, one or more of the layers or the entire image is represented using characteristic lines and background points.

In some embodiments of the invention, the image representation comprises characteristic lines, at least some of which are associated with bones of the skeleton. Optionally, the bones of the skeleton comprise characteristic lines of the image. Thus, some of the CORE Lines and points, while expressing color information, serve additionally as skeleton elements. Special markers (flags) are optionally used to specify each of the roles of a specific line. This leads to a dramatic data reduction and simplification of processing. Alternatively or additionally, one or more separate lines are defined for the bones.

Optionally, the motion of any point, associated to the skeleton, produced by the skeleton motion, is defined as follows: the coordinates of the new point with respect to the coordinate system for the moved skeleton are the same as the coordinates of the initial point with respect to the coordinate system of initial skeleton. Alternatively, only some of the motion of the points is defined using this method.

In some embodiments of the invention, some image pixels are associated to the skeleton (usually, pixel layers). Their motion is inferred by the skeleton motion in the same way. In some embodiments of the invention, an animation sequence may include indication of stretching and/or bending of a bone, resulting in a corresponding change in the associated image portion.

In some embodiments of the invention, in preparing animation based on an image, the image is cut into layers. For example, when the image shows a person, the hands, legs and body of the person may each be cut into a separate layer, for example manually or automatically (e.g., based on color or differences between images of a series of images). Each of the layers is then optionally converted into a CORE or VIM representation. Alternatively or additionally, the image is first compressed into the VIM representation and then is cut into layers.

Thereafter, a skeleton is optionally associated with the image. In some embodiments of the invention, a library skeleton is overlaid by an operator on the image, using a suitable graphic human interface. Alternatively or additionally, the operator draws bones of the skeleton on the image, using a suitable computer interface, for example freehand drawing or selecting a template from a library. The operator then indicates for each bone of the skeleton with which layer it is to be associated. Alternatively or additionally, the computer associates each bone with the closest layer and/or with the layer with a similar shape. In some embodiments of the invention, the computer replaces one or more defined bones,with substantially parallel characteristic lines of the associated layer, so as to reduce the amount of data stored for the image.

Thereafter, an animator defines the movement of the layers of the image, by defining movements of the skeleton.

There is thus provided in accordance with an exemplary embodiment of the invention, a method of representing an image, comprising:

determining one or more characteristic lines over which the profile of the image changes considerably; and

storing, for each of the one or more characteristic lines, one or more cross section profiles including data on the brightness of the line and of one or more background points adjacent the line having a brightness substantially different from the brightness of the line. Optionally, determining the one or more characteristic lines comprises determining a line which is different considerably from both its banks. Alternatively or additionally, determining the one or more characteristic lines comprises determining a line which is different considerably from one of its banks.

In an exemplary embodiment of the invention, storing one or more cross section profiles comprises storing, for each cross section profile, brightness values for at least three points along the cross section. Alternatively or additionally, storing one or more cross section profiles comprises storing, for each cross section profile, brightness values for at least five points along the cross section. Alternatively or additionally, storing one or more cross section profiles comprises storing, for each cross section profile, brightness values for at least two background points along the cross section. Alternatively or additionally, storing one or more cross section profiles comprises storing, for each cross section profile, data on the background points, which includes at least 25% of the stored data of the profile.

In an exemplary embodiment of the invention, storing data on the brightness comprises storing data on the color of the line. Alternatively or additionally, storing brightness data on one or more points not associated with the determined lines.

There is also provided in accordance with an exemplary embodiment of the invention, a method of representing an image, comprising:

providing one or more characteristic lines of the image; and

classifying each of the one or more lines as belonging to one of a plurality of classes with respect to its effect on constructing background points of the image. Optionally, classifying the lines comprises stating a separation level. Alternatively or additionally, classifying the lines comprises classifying into one of two classes. Optionally, the two classes comprise separating lines and non-separating lines.

There is also provided in accordance with an exemplary embodiment of the invention, a method of representing an image, comprising:

determining one or more characteristic lines over which the profile of the image changes considerably; and

storing, for at least one of the characteristic lines, a three-dimensional geometry of the line. Optionally, the method comprises storing for the one or more characteristic lines a cross section profile. Alternatively or additionally, storing the three-dimensional geometry comprises storing a two-dimensional geometry of the line along with at least one depth coordinate of the line.

There is also provided in accordance with an exemplary embodiment of the invention, a method of representing an image, comprising:

determining a characteristic line over which the brightness profile of the image changes considerably;

dividing the characteristic line into one or more segments according to the shape of the line;

selecting for each segment one of a plurality of model shapes to be used to represent the segment; and

determining, for each selected model, one or more parameter values, so that the model approximates the segment. Optionally, selecting the model shape comprises selecting from a group comprising an elliptic model. Optionally, selecting the model shape comprises selecting from a group comprising a circular model. Alternatively or additionally, selecting the model shape comprises selecting from a group comprising a parabolic model.

In an exemplary embodiment of the invention, determining the one or more parameters comprises determining end points of the segment and a maximal distance of the segment from a straight line connecting the end points.

There is also provided in accordance with an exemplary embodiment of the invention, a method of displaying a compressed image including a plurality of links, comprising:

determining for at least some of the pixels of the image, an associated link;

decompressing each of the links separately, without relation to the other links, so as to generate brightness values for a group of pixels in the vicinity of the link; and

selecting for the at least some of the pixels of the image a brightness value from the decompression of the associated link of the pixel. Optionally, determining the associated link is performed before the decompressing of the links. Alternatively, determining the associated link is performed after the decompressing of the links.

In an exemplary embodiment of the invention, determining the associated link comprises determining a nearest link.

There is also provided in accordance with an exemplary embodiment of the invention, a method of determining a display value of a pixel in an image represented by lines and a plurality of background points, comprising:

propagating lines from the pixel in a plurality of directions within the image;

delaying or terminating the propagating upon meeting lines of the image, according to a separation level of the line;

determining the distance to background points in the vicinity of the pixel, according to the propagating; and

calculating a brightness value for the pixel, according to the brightness values of the background points and determined distances to the background points. Optionally, propagating comprises propagating in a circular fashion.

There is also provided in accordance with an exemplary embodiment of the invention, a method of defining animation for an image, comprising:

providing a two-dimensional image;

providing a skeleton including at least one bone;

associating at least one of the bones of the skeleton with one or more portions of the image;

defining movements of the skeleton; and

moving the pixels of the portions of the image associated with moving bones of the skeleton, responsive to the movements of the bones. Optionally, defining movements of the skeleton comprises defining stretching of one or more bones of the skeleton.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is general representation of an image, in accordance with an embodiment of the present invention;

FIG. 2. shows a segment of a characteristic line with a color cross-section interpolated along it, in accordance with an embodiment of the present invention;

FIG. 3 shows an edge cross-section of a characteristic line, in accordance with an embodiment of the present invention;

FIG. 4 shows a separating ridge cross-section of a characteristic line, in accordance with an embodiment of the present invention;

FIG. 5 shows a non-separating ridge cross-section of a characteristic line, in accordance with an embodiment of the present invention;

FIG. 6 shows a parabolic mathematical model, representing patch, in accordance with an embodiment of the present invention;

FIG. 7 shows a background partition by characteristic lines, in accordance with an embodiment of the present invention;

FIG. 8 shows background representing points in different parts of the background partition, in accordance with an embodiment of the present invention;

FIG. 9 shows crossing of characteristic lines, in accordance with an embodiment of the present invention;

FIG. 10 shows splitting of characteristic lines, in accordance with an embodiment of the present invention;

FIG. 11 shows correlation of cross-section parameters of characteristic lines at their crossing, in accordance with an embodiment of the present invention;

FIG. 12 is a block-diagram of an image reconstruction method, in accordance with an embodiment of the present invention;

FIG. 13 shows the representation of the edge cross-section by parabolic pieces, in accordance with an embodiment of the present invention;

FIG. 14 shows the representation of the ridge cross-section by two edge cross-sections, in accordance with an embodiment of the present invention;

FIG. 15 illustrates gluing edge cross-section to the background, in accordance with an embodiment of the present invention;

FIG. 16 shows the weight functions used in the reconstruction algorithm, in accordance with an embodiment of the present invention;

FIGS. 17 and 18 show construction of the distance to the line segment, in accordance with an embodiment of the present invention;

FIG. 19 shows construction of the distance function near the ends of the line segments, in accordance with an embodiment of the present invention;

FIGS. 20A and 20B show patch and patch weight functions respectively, in accordance with an embodiment of the present invention;

FIG. 21 shows some possible shapes of the background weight function, in accordance with an embodiment of the present invention;

FIG. 22 illustrates the construction of the distance between the background points, taking into account separating lines, in accordance with an embodiment of the present invention;

FIG. 23 illustrates signal expansion process for constructing distance between background points, in accordance with an embodiment of the present invention;

FIG. 24 shows construction of margin background points near characteristic lines, in accordance with an embodiment of the present invention;

FIG. 25 is a flowchart of animation creation, in accordance with an embodiment of the present invention;

FIG. 26 shows a block-diagram, representing steps of a skeleton construction, in accordance with an embodiment of the present invention; and

FIG. 27A-C show bending and stretching of bones, in accordance with an embodiment of the present invention.

### DETAILED DESCRIPTION OF EMBODIMENTS

In the present application, as in the documents listed in the related applications section above, the following terms are used interchangeably:

The specific format for vector representation of images and scenes, disclosed in the present invention, is below referred as VIM (Vector Imaging) images, VIM Textures and VIM scenes.

The lines used to define the images are referred to as Characteristic Lines and Lines (LN). The lines are formed of segments referred to as Line Segments (LS), Links and Arcs. A single point along a characteristic line is referred to as a Line Point (LP) or a vertex. Along the lines there are one or more Line Color Profiles (LC), referred to also as Cross-Sections, which define the change in the image across the line.

In the compressed format, the image is further defined by points each of which is referred to as an Area Color Point (AC), a Background representing point or a Background point.

Some images may be defined by a plurality of separate portions referred to as Sub-Textures (ST) and Layers.

Characteristic Lines and their Color Cross-Sections

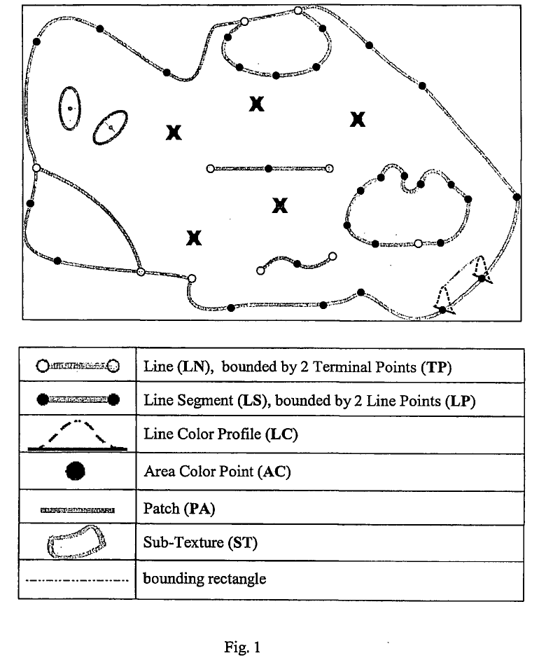

FIG. 1 is general representation of an image, in accordance with an embodiment of the present invention.

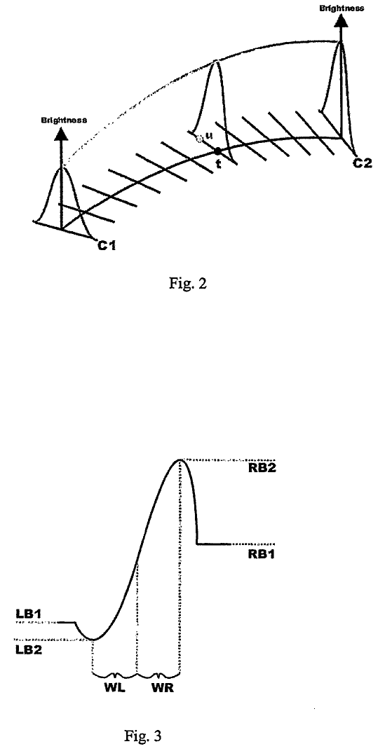

FIG. 2. shows a segment of a characteristic line with a color cross-section interpolated along it, in accordance with an embodiment of the present invention. Characteristic Lines and their Color Cross-Sections have been defined in U.S. patent applications Ser. Nos. 09/716,279 and 09/902,643, the disclosures of which documents is incorporated herein by reference. Optionally, characteristic lines are lines on the image along which the image visual pattern consistently repeats itself. Characteristic lines are optionally represented by their “central lines” and “brightness cross-sections”. The central line captures in the most accurate way the geometric shape of the characteristic line, while the brightness cross-section describes the brightness (color) behavior in the orthogonal sections of the line. Cross-sections optionally represent the visual pattern, that repeats itself along the line.

In some embodiments of the invention, the central line is represented by a second or third order spline curve (preferably a second order). Optionally, each cross-section is represented by one of a number of model shape types, each characterized by a small number of parameters. In an exemplary embodiment of the invention, the model shape types include parabolic, elliptic and circular curves. Alternatively or additionally, other curves may be used. Cross-sections are stored at predefined points (referred to as “cross-section control points”) on the central line, and interpolated between these control points.

Parameters of Characteristic Lines' Geometry

All the geometric parameters below are described in the coordinate system (x,y) in the image plane, with the unit length taken to be the distance between two neighboring pixels. The endpoints of the characteristic lines and their crossings, are called “joints”. Other points on the lines can also be defined as joints. If a characteristic line forms a simple closed curve, one of its points is chosen to be a joint. Simple (i.e. without crossings) characteristic lines, connecting joints, are called below “poly-links”. Optionally, all the joints on the VIM image are described (in a certain order) by their coordinates (x,y) in the above coordinate system. In some embodiments of the invention, the central lines of the characteristic lines between the joints (i.e. the poly-links) are represented by special second order splines, that are called P-curves.

In some embodiments of the invention, a P-curve is a chain of convex arcs Sᵢ, i=1, 2, . . . , n, starting at the point z₀=(x₀, y₀) and ending at the point zₙ=(xₙ, yₙ). The arcs Sᵢ and Sᵢ+1 have the common point zᵢ=(xᵢ, yᵢ), called a vertex. For a closed curve the initial point z₀ and the end point zₙ may coincide. Being represented by an ordered list of consecutive points, each P-curve possesses a natural orientation. In some embodiments of the invention, either parabolic, elliptic or circular arcs Sᵢ are used, in such a way that for each [zᵢ₋₁-zᵢ] the arc Sᵢ is completely characterized by the height hᵢ of its center over the segment [zᵢ₋₁-zᵢ]. Without loss of generality, this height is optionally taken with the sign plus, if the arc is curved to the left side of the P-curve, and with the sign minus, if the arc is curved to the right.

If the parabolic arcs Sᵢ are chosen, they are optionally taken to be symmetric with respect to the line passing through the center of the straight segment [zᵢ₋₁, zᵢ] and orthogonal to it. Thus for [zᵢ₋₁, zᵢ] given, the symmetric parabolic arc Sᵢ is completely characterized by the height hᵢ of its center over the segment [zᵢ₋₁, zᵢ].

Consequently, in some embodiments of the invention, a P-spline curve is given by the following parameters:

The coordinates (xᵢ, yᵢ) of the vertices zᵢ, i=0, 1, . . . , n, and the heights h_{i , i=}1, . . . , n, of the arcs sᵢ. In some embodiments of the invention, rather than storing the absolute coordinates, the coordinates (x₀, y₀) of the starting point z₀, are stored with the vector coordinates (vᵢ, wᵢ) of the segments [zᵢ₋₁, zᵢ], i=1, . . . n, for the rest, vᵢ=xᵢ−xᵢ₋₁, wᵢ=yᵢ−yᵢ₋₁.

The arcs Sᵢ of the P-curves, representing poly-links, are referred to below as “links”.

To summarize, in an exemplary embodiment of the invention, the central lines of the characteristic lines of a VIM image are completely described by the following parameters:

1. The list of the joints, with their coordinates.

2. The list of poly-links, specified by their vertices. Since the choice of one of two possible orientations of the poly-link is important in some embodiments of the invention, each poly-link is optionally given by an ordered list of its vertices zᵢ, starting at one of the endpoints of the poly-link and continuing following the natural order of the vertices, together with the heights of the corresponding links. Alternatively, the vectors [zᵢ₋₁, zᵢ] and the heights can be specified.

Parameters of Brightness Cross-Sections

Cross-sections are optionally specified at the cross-section control points along each poly-link, including their end points. In a basic profile default configuration, described below, the cross-section control points optionally coincide with the vertices of the P-curves, representing the poly-link. In some embodiments of the invention, each cross-section has a type, optionally either edge or ridge. Generally, an edge is a line, separating two areas of the image with different brightness (color) levels. A ridge is a line, representing a thin strip, which differs in its brightness (color) from the brightness (color) on each of its sides. The type of the cross-section (edge or ridge) does not change along the poly-links between the joints. In some embodiments of the invention, each ridge (i.e. a poly-line with the ridge type of the cross-section) is marked either as a “separating” or as a “non-separating” line. Edges are optionally always separating.

Edge Cross-Section

FIG. 3 shows an edge cross-section, in accordance with an embodiment of the present invention. Optionally the edge cross section is described by the following parameters: Left width WL, Right width WR, Left brightness LB1, Left brightness LB2, Right brightness RB1 and Right brightness RB2. Optionally, the Left width WL and the Right width WR are always assumed to be equal. Alternatively or additionally, the Left width WL and Right width WR are equal by default unless otherwise specified.

In some embodiments of the invention, the edge cross-section is assumed to have “bumps” defined by the differences between RB1 and RB2 and LB1 and LB2, respectively. These bumps are used to better represent natural images, either scanned or taken by a video or a still digital camera. The bumps are generally caused by the physics of the light propagation, by specifics of scanning procedures and/or by specifics of human visual perception.

However, for images of a different origin (for example, for synthetic computer-generated images) quite different shapes of the cross-sections appear. This is true also for certain types of scanners, and especially, for other sensors, like infra-red ones. In more advanced profiles of VIM representation fairly general shape models of cross-sections can be used. These cross-sections are represented by spline curves and are tuned according to the image specifics.

The “margin” parameters LB1 and RB1, being important cross-section features, are stored together with other cross-section parameters. However, they have another natural visual interpretation as the background brightness along the edge on its different sides. It is this interpretation, that is optionally used in the recommended reconstruction algorithm: the margin cross-section parameters enter the Background reconstruction Procedure, while the rest of the cross-section parameters are treated in the Cross-section reconstruction Procedure.

In some applications, the “height” of the cross-section bump can be taken to be a certain fixed fraction of the total height of the cross section. This fact is optionally utilized in the “aggregation” level of the VIM representation, by encoding of the actual heights as the corrections to the default ones. In some implementations of this mode, the parameters LB2 and RB2 are eliminated and replaced by their default values, computed through the rest of the parameters.

Separating Ridge Cross-Section

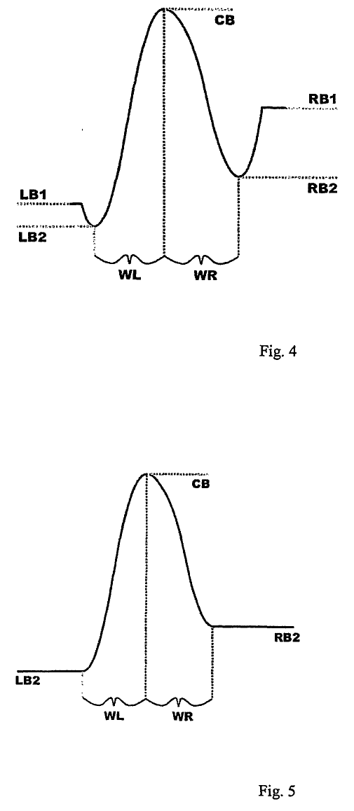

FIG. 4 shows a separating ridge cross-section, in accordance with an embodiment of the present invention. Optionally, a ridge cross-section is described by the following parameters: Left width WL, Right width WR, Left brightness LB1, Left brightness LB2, Central brightness CB, Right brightness RB1 and Right brightness RB2.

Optionally, the remarks above, concerning the nature of the bumps and the redundancy of the side brightness parameters, as well as the interpretation of the margin brightness parameters LB1 and RB1 as the Background values, remain valid also for ridges.

Non-Separating Ridge Cross-Section

FIG. 5 is an exemplary cross-section graph of a non-separating ridge, in accordance with an embodiment of the present invention. This type of cross-section has the same parameters as the separating one, besides the margin parameters LB1 and RB1, which are not defined.

On the aggregation level various default configurations can be adopted, simplifying data representation. For example, the right and the left width of the ridge are usually roughly equal, so a single width parameter can optionally be used. Alternatively or additionally, the right and left brightness values of a non-separating ridge can be identified with the background values at the corresponding points.

If a color image is represented, all the brightness parameters are defined independently for each color component, while the same width parameters are kept. These color components can be R, G, B, CMYK, YUV or other formats. Below we use the word “brightness” to denote any component of these color formats. As stated above, the cross-sections are specified at each vertex of the poly-line, including the endpoints, which are joints.

To summarize, cross-sections of characteristic lines are specified by the following parameters:

Type of a cross-section (edge, ridge or separating ridge) for each poly-link.

Width and brightness parameters of the cross-sections, as specified above, at each of the vertices of the P-curves, representing poly-links.

In color images, the type and width of the cross-sections are optionally the same for each color component, while the brightness parameters are specified independently for each color.

On a higher aggregation level, various known visual spatial-color correlations can be used to reduce the data size. For example, the brightness of the bumps can be stored as a correction to a default value, equal to a certain percentage (typically around 10%) of the total brightness jump.

A closed chain of poly-links without self-intersections is optionally marked as a boundary contour of the VIM image.

Patches

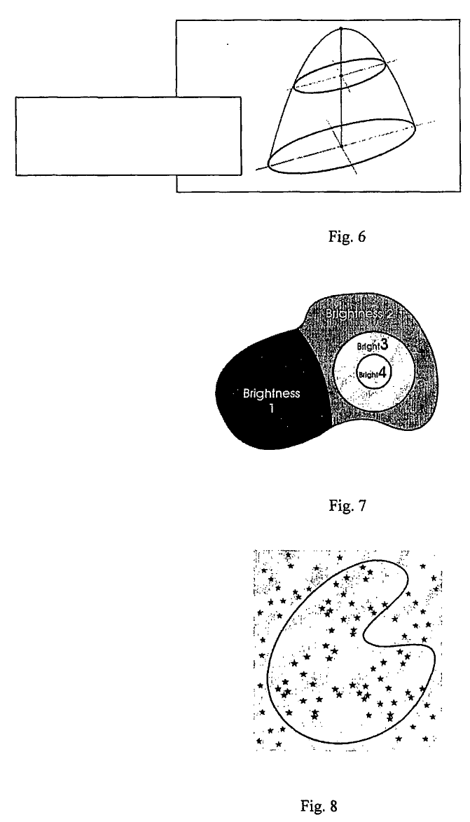

FIG. 6 is a schematic illustration of a patch, in accordance with an embodiment of the present invention. Patches optionally capture fine scale brightness maxima and minima. They are represented by Gaussian-shaped or parabolic-shaped mathematical models, blended with the background along their elliptic-form margins. In some embodiments of the invention, each patch is specified by the following parameters: the coordinates (Cx, Cy) of its center, the sizes R1 and R2 of the bigger and the smaller semi-axes of a base ellipse, the direction a (angle with the x-axis) of the main semi-axis of the base ellipse, the brightness value CB at the center and the “margin” brightness value MB. Optionally, in color images, the brightness values at the center of each patch are specified independently for each color separation.

On the aggregation level various default configurations can be adopted, simplifying data representation. For example, for patches smaller than a few pixels in size, the distinction between the sizes of the two semi-axes of the elliptic base is hardly visually appreciated, and therefore a single size parameter is used and/or the angle a is omitted. Alternatively or additionally, the margin brightness value MB of the patch is not stated and the Background brightness at the patch center is used instead.

The Background

This background refers herein to the part of the VIM image, “complementary” to the characteristic lines. In some embodiments of the invention, the background includes slow scale image components. The background is optionally determined by one or more of the following elements:

1. All the separating characteristic lines are excluded from the background domain.

2. Some of the image subparts, completely bounded by separating characteristic lines or/and the image borders, are provided with their single global background brightness value GB. In fact, these subparts, called VIM Sub-Textures, play an important role on higher representation and animation levels. They are specified by Sub-Texture numbers, and the values GB are attached to the Sub-Textures.

FIG. 7 shows background parts with different GB values.

3. A certain number of background representing points is defined, each point carrying its brightness or its color value. These values are further interpolated between the background representing points in such a way that the interpolation does not “cross” the separating characteristic lines. See FIG. 8.

4. The margin brightness values of the cross-sections of separating characteristic lines are blended with the background along the margins of these separating lines.

Parameters of the Background

The following parameters participate in the calculation of the background brightness values (as described in detail in the Procedure BB below):

Geometric parameters of all the separating characteristic lines.

Margin brightness values (LB1 and RB1 above) of the cross-sections of all the separating characteristic lines.

List of the “background representing points”, each one given by its (x,y) coordinates and its brightness value.

Single background global brightness values GB for some of the Sub-Textures. In the parameters structure these values are associated with the Sub-Texture numbers, which, in turn, are associated with the poly-links, bounding the Sub-Texture.

On the aggregation level various default configurations can be adopted, simplifying data representation. In particular, a regular grid of background representing points can be used, to eliminate the need to store coordinates of these points. (Notice, however, that in a general structure in accordance with one exemplary embodiment of the invention, allowing, in particular, for geometric transformations and animations of the images, all the geometric parameters must be represented in a geometrically invariant form, without reference to a fixed grid).

Crossings

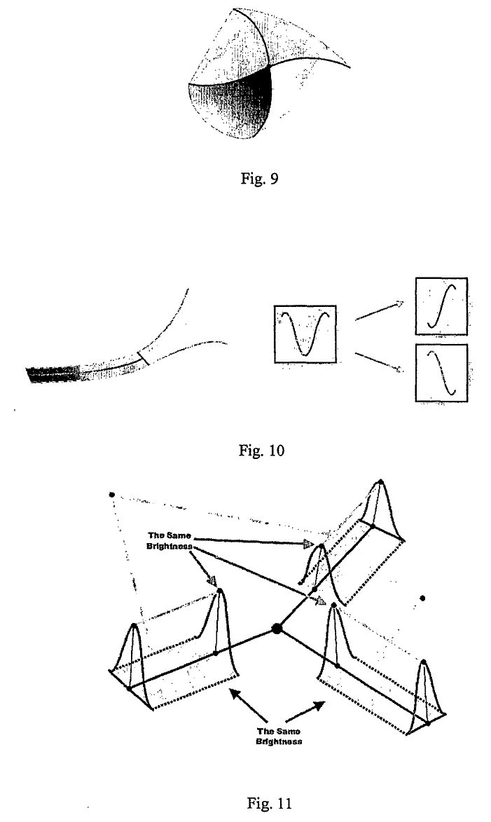

Crossings of characteristic lines are represented by crossings of their central lines and by blending of their brightness values near the crossings. See FIG. 9.

Splitting is a special type of crossing, where the characteristic line splits into two or more new characteristic lines, according to a splitting of the cross-section into the corresponding sub-pieces. See FIG. 10, for example. In the data structure described above, crossings and splittings are optionally represented by joints. At each joint cross-sections are given for each of the characteristic lines starting (or ending) at this joint. No compatibility conditions between these cross-sections are assumed in the basic VIM profile.

However, in some situations, the side brightness (color) values on appropriate sides of the adjacent characteristic lines at their crossing, are roughly equal. This fact is optionally used on the higher aggregation level to reduce the data size. (See FIG. 11, for example).

Splitting of a ridge is a special type of crossing, where a ridge, becoming wider, splits into two edges. This is a frequently appearing type of a crossing, and its specific structure (adherence of the cross-sections and of the geometric directions of the ridge and the two edges) is used on the higher aggregation level to reduce the data size and to preserve the image visual continuity along the characteristic lines. See FIG. 4, for example.

The parameters of the images are optionally aggregated along the Characteristic Lines, at the Crossings of characteristic lines in the represented image and/or between the Characteristic Lines and the Background. This includes storing the Cross-Section parameters of Characteristic Lines at their Crossings, then interpolating them along the Line and using these interpolated data either as the final one or as a prediction. In the last case the actual Cross-Section parameters at the Line Points are given by the corrections to the predicted values. The same procedure can be performed for the Background values at the Crossings and along the lines. Thus, the stability of the image representation is increased and the amount of data required for representation is reduced.

Associating Depth to CORE/VIM Images

Depth value can be associated to each of the CORE/VIM elements, thus making the image three-dimensional. In a preferred implementation depth value is added to the coordinates of each of the control points of the splines, representing characteristic lines, to the center coordinates of patches and to the coordinates of the background points. Alternatively, depth values are associated with the Color Cross-section parameters of the characteristic lines.

Layers of VIM Images

In some embodiments of the invention, some parts of the VIM image, optionally bounded by characteristic lines, are defined as Layers. VIM Layers can move independently of one another, and, being three-dimensional objects, they may occlude one another. VIM Layers are also called VIM Sub-Textures.

Objects of VIM Images

In some embodiments of the invention, certain groups of VIM Layers are defined as VIM Objects. A rigid motion of VIM Objects in the ambient 3D space is allowed. VIM Skeletons are normally associated to VIM Objects, as described below.

Reconstruction Algorithm

The reconstruction algorithm starts with the input parameters, described above, and comprises the following main procedures, exemplary embodiments of which are described below:

Computing Brightness of Characteristic Lines (Procedure BL)

In order to compute the brightness values of the cross-sections along the characteristic line, a coordinate system (u,t) is associated to its central line. Here u is the distance from the central line (with the sign) and t is the coordinate (along the line) of the projection on the central line.(Procedure DL). Using the coordinates (u,t) the brightness of the cross-sections (computed in the Procedure CS) is interpolated between the control points to a complete neighborhood of the characteristic line.

Computing brightness of Patches (Procedure BP)

The brightness of a patch is optionally computed using a certain Gaussian—type brightness function, with the basis (in the image plane)—for example an ellipse, defined by the input patch parameters, and the height of the vertex equal to the input brightness parameter. A specific choice of the model Gaussian—type brightness function is influenced by the same considerations as the choice of the cross-sections model shapes. In particular, it can be taken to be a paraboloid with the elliptic basis and the vertex as specified by the input parameters (procedure BP).

Computing Brightness of the Background (Procedure BB)

Background brightness values are computed by an interpolation between the brightness values of closed background components, the margin brightness values of the separating characteristic lines and the brightness values of the background representing points. The interpolation process is performed in such a way that the interpolation does not “cross” the separating characteristic lines (Procedure BB).

In some embodiments of the invention, the interpolation process includes a “signal expansion algorithm”, in which the background representing points (and the margins of separating lines) transmit their brightness value to the neighboring pixels, which in turn transmit it to their neighbors, etc. In this expansion the signal is transmitted only to the neighboring pixels, lying on the same side of each of the separating characteristic lines. Finally the background brightness value is computed at each pixel as a weighted average of the brightness values, received by this pixel in the process of signal expansion. The weights reflect the distances to corresponding background representing points.

In some embodiments of the invention, the range of the signal expansion from each background representing point is limited to a certain constant, reflecting the density of the background representing points. Under a proper choice of this constant, (usually as 2-3 times the typical distance between the background representing points), the above algorithm is computationally very efficient, since only a few operations are performed per each pixel.

Blending the Computed Brightness Values into the Final image (Procedure MAIN)

The final brightness values of a VIM image are computed as the values of the characteristic lines, patches or the background at the interior pixels of the corresponding parts of the image. At the margin areas of the characteristic lines and of the patches the final brightness is computed by averaging their brightness values with the background brightness, with the weights compute in the Procedures WL and WP, respectively. To simplify the presentation we assume below that the right width WR and the left width WL of the ridge cross-sections are always the same and use a single width parameter W.

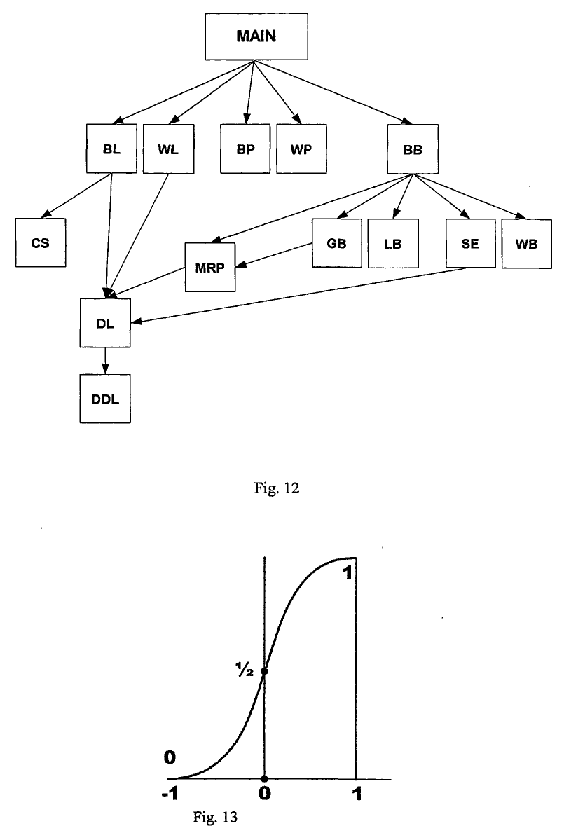

FIG. 12 is a flowchart of acts performed in reconstructing an image from a CORE representation, in accordance with an embodiment of the present invention.

Reconstruction Algorithm

As described above, the reconstruction algorithm starts with the input parameters, as above, and computes the brightness (color) value of the VIM image at each given point z in the image plane. In the case of a color image these computations are performed for each color component. In the description of each Procedure below, the names of the Procedures, called in the process of computations, are stressed.

Procedure MAIN: Computing the Final Brightness Values

For any point z in the image plane the final brightness B(z) of the VIM image at the point z is computed according to the following formula:

$$B ( z ) = \frac{WL ( z ) \cdot BL ( z ) + WB ( z ) \cdot BB ( z ) + {\sum }_{s} {WP}_{s} ( z ) \cdot {BP}_{s} ( z )}{WL ( z ) + WB ( z ) + {\sum }_{s} {WP}_{s} ( z )} \qquad ( 1 )$$

Here BB(z), BL(z) and BPₛ(z) are the brightness functions of the background, of the characteristic lines and of the patches, computed in the Procedures BB, BL and BP, respectively, and the sum

$${\sum }_{s}$$

runs over all the patches Pₛ.

The weight functions WL(z) and WPₛ(z) are computed in the Procedures WL and WP, respectively, and WB(z)=1−max(WL(z), WPₛ(z)). Optionally, division by the sum of all weight functions in formula (1) guarantees that their sum is identically 1 and that formula (1) is a true averaging.

Procedure BL: Brightness of Characteristic Lines

This procedure computes for any point z on the image the brightness BL(z), as defined by the cross-sections of the characteristic lines. Optionally, BL(z) needs to be computed only for those z which are “close enough” to at least one of the characteristic lines in the texture, as expressed by the weight function WL. The most intuitive and natural way to define the brightness of a characteristic line is to associate to it a coordinate system (uu, tt), with uu(z) the (signed) distance of the point z to the line along the normal direction, and tt(z) the length parameter along the curve of the orthogonal projection pp(z) of z onto the line. Then the brightness cross-sections are computed according to the coordinate uu and interpolated along the line with respect to the coordinate tt.

The corresponding algorithm can be constructed. However, it provides some serious drawbacks:

1. Actual computing of the coordinates uu and tt is mathematically complicated task

2. Even for smooth curves without corners the normal direction is correctly defined only in a small neighborhood of the curve (of the size of a couple of pixels in realistic situations). Outside this neighborhood no natural mathematical solution exists for defining the normal, the projection etc.

3. For spline curves with corners between some of their links (which usually appear in realistic situations) the normal is not defined even locally. Once more, the situation can be corrected by introducing the bissectrices of the corner angles, but the global difficulties of p.2 remain and algorithms become rather involved

Consequently, an algorithm, which can be considered as an approximation to the “ideal one” above, is described below. Its main advantage is that the “coordinates” uu and tt (called below u and t) can be computed independently for each link of all the collection of characteristic lines. Moreover, the computation can be ultimately rendered as very efficient.

Below for any point z, u(z) is the “distance of z to characteristic lines”, S(z) is the closest link to z (with respect to the distance u) in the collection of characteristic lines, and t(z) is the parameter, measuring the projection of z onto S(z), rescaled to the segment [0, 1]. S(z), u(z) and t(z) are computed by the Procedure DL, described below.

The Procedure BL splits according to whether the link S(z) has a “free end” (i.e. an endpoint, not belonging to any other link) or not.

The Case Where S(z) does not have “Free Ends”

Let C₁ and C₂ denote the equations of the two cross-sections (normalized to the unit width, as described in the Procedure CS below) at the two endpoints of the link S(z). For u(z)>0 let W₁ and W₂ denote the respective right widths RW₁ and RW₂ of the cross-sections at these points. For u(z)<0 let W₁ and W₂ denote the respective left widths LW₁ and LW₂ of the cross-sections at these points. Then in each case

$$BL ( z ) = t ( z ) \cdot {C}_{1} ( \frac{u ( z )}{W ( z )} ) + ( 1 - t ( z ) ) \cdot {C}_{2} ( \frac{u ( z )}{W ( z )} )$$

where W(z) is the interpolated width

W(z)=t(z)·W₁+(1−t(z))·W₂

and the values

$${C}_{1} ( \frac{u ( z )}{W ( z )} )$$

and

$${C}_{2} ( \frac{u ( z )}{W ( z )} )$$

are computed by the procedure CS. FIG. 2 illustrates this construction. The Case Where S(z) has a “Free End”

If for this “free end” the parameter t is zero, the brightness BL(z) is computed as above for t(z)>0. For DE<t(z)<0,

$$BL ( z ) = [ 1 + t ( z ) / DE ] {C}_{1} ( \frac{u ( z )}{W ( z )} ) - [ t ( z ) / DE ] \cdot BM ,$$

and for t(z)<DE,

BL(z)=BM.

Here DE is a positive tuning parameter, defining the shape of the end of a characteristic line. BM is half of the sum of the brightness parameters LB2 and RB2 of the cross-section at the free end.

If for this “free end” the parameter t is one, t(z) is replaced by 1−t(z) in the above formula. The formula above provides one of possible choices of the shape of characteristic lines near their ends. It assumes that the cross-section brightness gradually descends to the “middle basis” value BM inside the prescribed distance DE. Other shapes can be defined, by properly computing the width and the brightness in the neighborhood of the end point. This is done by specifying a shape of the characteristic line near the end (for example, circular, elliptic or parabolic), computing the cross-section width according to the chosen shape, and rescaling the brightness cross-section accordingly.

Procedure CS: Cross-Sections of Characteristic Lines

The CS procedure computes a brightness value of an edge or a ridge (unit width) cross-section CS(u) for any given cross-section “interior” brightness parameters, as described above, and for any value of u. In the Procedure BL, u is the distance u(z) to the line, normalized by the width W(z) of the line, so the width parameter W is taken into account inside the BL, and it does not appear below. Similarly, the margin brightness parameters LB1 and RB1 enter the computations in the Background brightness Procedure BB.

Edge Cross-Section

Normalized edge cross-section NEC(u) is defined as follows:

NEC(u)=0 for u<−1, NEC(u)=1 for u>1.

NEC(u)=(½)(u+1)² for −1<u<0, and

NEC(u)=1−(½)(u−1)² for 0<u<1. (See FIG. 13, for example).

Thus the recommended edge cross-section is composed of two symmetric parabolic segments.

For given brightness parameters LB2 and RB2, the value CS(u) is optionally computed as CS(u)=LB2+(RB2−LB2)*NEC(u)

Ridge Cross-Section

As for edges, the width of the ridges is taken into account in the Procedure BL. Similarly, the margin brightness parameters LB1 and RB1 enter the computations in the Background brightness Procedure BB. Consequently the ridge cross-section computed in the current Procedure CS, is the same for separating and non-separating ridges, and is defined by the parameters LB2, CB and RB2, as follows:

CS(u)=LB2+(CB−LB2)*NEC(2u+1), for u<0, and

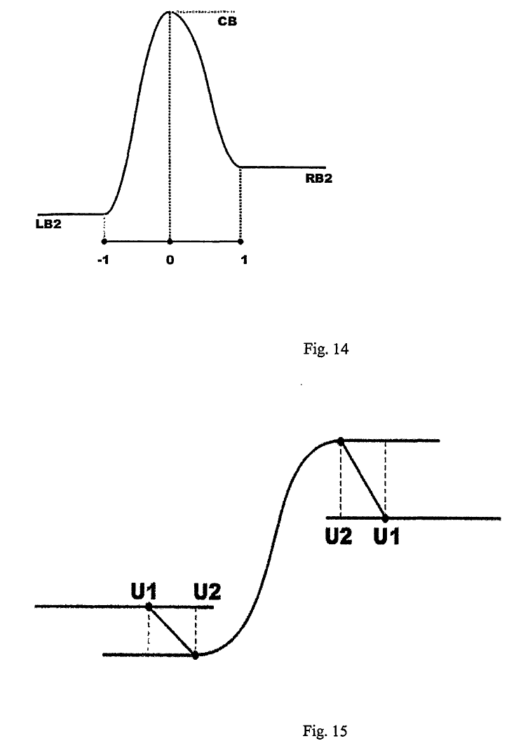

CS(u)=RB2+(CB−RB2)*NEC(−2u+1), for u>0. (See FIG. 14, for example).

Thus the recommended ridge cross-section is composed of two edge cross-sections, properly aggregated. In the process of blending of these cross-sections with the background (which incorporates the margin brightness values LB1 and RB1) one obtains back essentially the same cross-section, as shown on FIG. 3 and FIG. 4 above. See FIG. 15, for example.

Procedure WL: Weight Function of Characteristic Lines

This block computes the weight function WL(z), which is used in a final blending of the characteristic lines with the background. The function WL(z) is equal to one in a certain neighborhood of the characteristic lines, and is zero outside of a certain larger neighborhood. More accurately:

$$\{ \vert \begin{matrix} & 1 & \vert u ( z ) \vert < {UL}_{2} \cdot W ( z ) \\ WL ( z ) = & \frac{W ( z ) \cdot {UL}_{1} - \vert u ( z ) \vert}{W ( z ) \cdot ( {UL}_{1} - {UL}_{2} )} & {UL}_{2} \cdot W ( z ) < \vert u ( z ) \vert < {UL}_{1} \cdot W ( z ) \\ & 0 & \vert u ( z ) \vert > {UL}_{1} \cdot W ( z )\end{matrix}$$

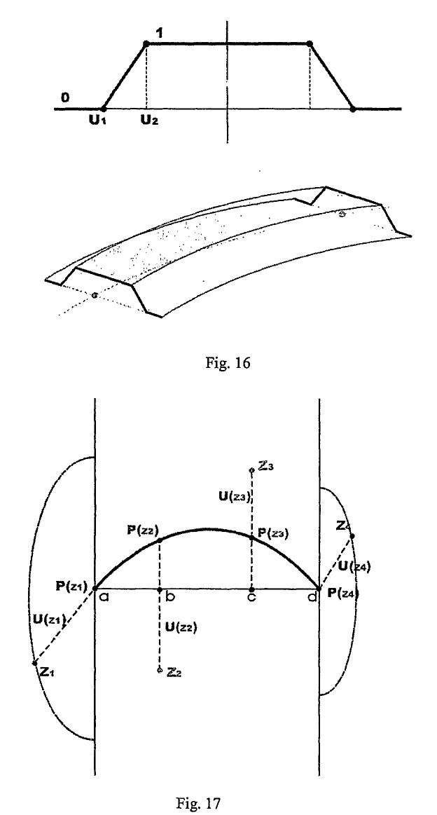

The distance u(z) is computed in the Procedure DL. UL₁ and UL₂ are tuning parameters, see the last section “Tuning Parameters”. FIG. 16 below shows a typical cross-section and a general shape of the weight function WL(z), in accordance with an embodiment of the present invention.

Procedure DL: Distance to Characteristic Lines

This Procedure optionally computes for any point z in the texture the point p(z) on the characteristic lines which is nearest to z, i.e. its the “projection” of z onto the set of characteristic lines, the distance u(z) between z and p(z), the link S(z) on which p(z) resides and the proportion t(z) in which p(z) divides the link S(z).

In some embodiments of the invention, u(z), p(z) and t(z) are not exactly the Euclidean distance, the corresponding mathematical projection and proportion respectively; however, in most cases they give a reasonable approximation for these mathematical entities. Alternatively or additionally, the Euclidean distances and/or other distances are used.

These data are computed in the following steps:

For each link Si in the texture, the corresponding pᵢ(z), uᵢ(z), tᵢ(z) are computed in Procedure DDL (See FIG. 17)

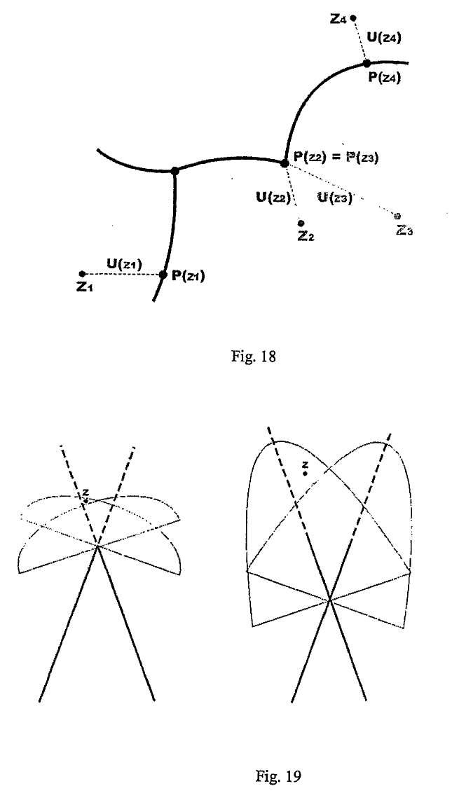

S(z) is defined as the link Sⱼ, for which the minimum of the absolute values |uᵢ(z)| is attained (See FIG. 18)

u(z) is defined as the function uⱼ(z) for the link Sⱼ=S(z)

t(z) is defined as tⱼ(z) for the above link Sⱼ

Procedure DDL: Distance to a Link

This procedure computes for any point z its (signed) distance u(z) to a given link S, the projection p(z) of the point z onto the link S and the parameter t(z). The Procedure is essentially represented on FIG. 17 (which shows, in particular, equidistant lines for the points z₁ and z₄.

The straight oriented segment [a, d], joining the end points of the link S is constructed, with the orientation, induced from the orientation of the poly-link, containing S. l₁ is the straight line, containing the segment [a, d]. l₂ and l₃ are the straight lines, orthogonal to l₁ and passing through a and d, respectively.

For any z in the image plane, the function u(z) is constructed as follows:

For z between l₂ and l₃, the absolute value |u(z)| is the length of the segment, joining z and S and orthogonal to l₁.

For z left to l₂, |u(z)| is defined as |u(z)|=[d(z, l₁)²+Dd(z, l₂)²]^{1/2}, where d(z, l₁) and d(z, l₂) are the distances from z to l₁ and l₂ respectively, and D is a tuning parameter, with a typical value D=4.

For z right to l₃, |u(z)| is defined as |u(z)|=[d(z, l₁)²+Dd(z, l₃)²]^{1/2}.

Let l1 be an oriented line, formed by the interval of the line l₁ from infinity to a, then by the link S from a to d, and then by the interval of the line l₁ from d to infinity. For z right to l1 (with an orientation as above) the sign of u(z) is “+”. For z left to l1, the sign of u(z) is “−”. For z between l₂ and l₃, the projection p(z) is the intersection point of S and of the segment, joining z and S and orthogonal to l₁. For z left to l₂, p(z) is a, and for z right to l₃, p(z) is d.

For any z, t(z) is the proportion, in which the projection of z onto the line l1 subdivides the segment [a, d]. For example, for the point z₂ and z₃ on FIG. 18. t(z₂)=(b-a)/(d-a), and t(z₃)=(c-a)/(d-a), respectively. For z left to l₂, t(z)<0, and for z right to l₃, t(z)>1.

The special form of the function u(z) above (for z outside the strip between l₂ and l₃) is motivated by the following reason: when computing in the Procedure BL the brightness of the line near a sharp corner, the form of the distance function u(z) determines which link will be taken as the closest to the points in the sector stressed on FIG. 19. The form as above, with the parameter D>1, this choice is in agreement with the sign of u(z), as defined above. Would one take D<1, for z in the sector stressed on FIG. 19, the choice of the nearest link, together with the proposed computation of the sign of u(z), would produce a color from the incorrect side of the line. See FIG. 19, for example.

Procedure BP: Brightness of Patches

Let x₀, y₀, R1, R2, a, PB and MB be the parameters of a certain patch Pₛ, as described above. Let M be the linear transformation of the plane, transforming the basis ellipse of the patch to the unit circle. M is a product of the translation by (−x0, −y0), the rotation matrix to the angle−a, and the resealing 1/R1 and 1/R2 times along the x and y axes, respectively. If put for z=(x, y), (x′(z), y′(z))=M(x, y)=M(z), then the equation of the basis ellipse of the patch is given by x′(z)²+y′(z)²1.

The brightness function BPₛ(z) of the patch is then given by

BPₛ(z)=0 for x′(z)²+y′(z)²>UP1²,

BPₛ(z)=BM for 1<x′(z)²+y′(z)²<UP1², and

BPₛ(z)=BM+(BP−BM)(1−x′(z)²+y′(z)²) for x′(z)²+y′(z)²<1.

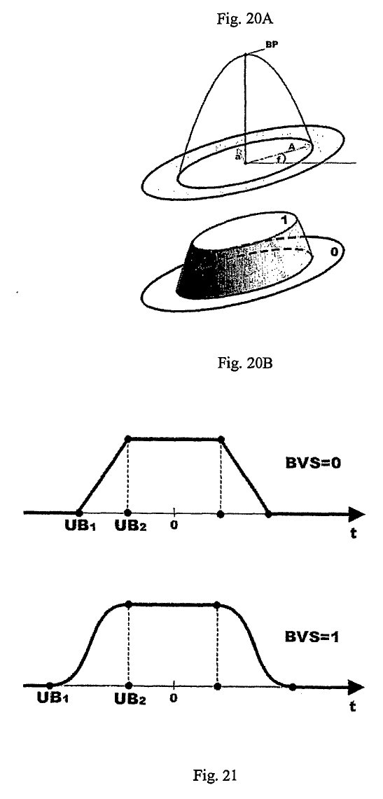

Here UP1>1 is a parameter. See FIG. 20A.

Procedure WP: Weight Function of Patches

The weight function WPₛ(z) for a patch Ps as above is defined by

WPₛz)=0 for uu(z)>UP1, WPₛ(z)=1 for uu(z)<UP2,

and WPₛ(z)=(UP1−uu(z))/(UP1-UP2) for uu(z) between UP2 and UP1,

where uu(z) denotes the square root of x′(z)+y′(z)

Here UP2, 1<UP2<UP1, is another tuning parameter. See FIG. 20B.

Procedure BB: Brightness of Background

This Procedure computes the brightness value of the background at any point z of the image. This value is obtained as a result of interpolation between the “global” background brightness values, the margin brightness values of the characteristic lines and the brightness values at the background representing points. The main difficulty is that the interpolation is not allowed to cross the separating lines. To overcome this difficulty a special “distance” d between the points on the image is introduced and computed in the Procedure SE below. Then averaging weights are computed through the distance d.

This block uses as an input a certain collection of the background representing points Zᵢ, (containing the input background representing points, as described in the Addendum A above, and the margin representing points, produced by the block “MRP”, described below). At each point Zᵢ the brightness value Bbᵢ is given.

The background brightness value BB(z) is finally produces by the block BB as follows: BB(z) is the weighted sum of the global brightness GB and of the Local brightness functions Bbᵢ(z) over all the background representing points Zᵢ:

$$BB ( z ) = ( 1 / {S}_{1} ( z ) ) [ WG ( z ) BG + {\sum }_{i} WR ( d ( z , {Z}_{i} ) ) {Bb}_{i} ( z ) ] . \qquad ( 2 )$$

$$Here {S}_{1} ( z ) = WG ( z ) + {\sum }_{i} WR ( d ( z , {Z}_{i} ) ) ,$$

so the expression (2) is normalized to provide a true averaging of the corresponding partial values. The global brightness value BG is provided by the Procedure GB below. The computation of the Local brightness functions Bbᵢ(z) is performed in the Procedure LB below. The distance functions d(z, Zᵢ) are computed in the Procedure SE below. The computation of the weight functions WR(d(z, Zᵢ)) is performed in the Procedure WB below.

The weight GW(z) of the global background value GB is defined as

GW(z)=1−maxᵢ(WR(d(z, Zᵢ))).

In particular, GW(z) is zero at any z, where at least one of the weights of the representing points is 1, and GW(z) is one at any z where all the weights of the background representing points vanish.

Procedure GB: Global Brightness of Background

This Procedure computes the global background value GB, which appears in the expression (2) in the Procedure BB. By definition, if the point z is inside the background region of a Sub-Texture number r, for which the global value GBᵣ is defined, GB is equal to this global value GBᵣ. If the point z is inside the background region of a Sub-Texture, for which the global background value is not defined, GB is equal to the default global value DGB. If DGB is not defined, GB is equal to zero.

The current procedure consists in a signal expansion, that transmits to each pixel its Sub-Texture number. We describe it shortly, since it essentially belongs to a higher data representation layer.

First the procedure MRP is applied, which creates margin representing points, carrying the corresponding Sub-Texture numbers. These numbers are taken from the corresponding poly-links.

Second, the Signal Expansion Procedure is applied to the margin representing points, essentially as in the block SE, with the following difference: only the marking and the number of the Sub-Texture is transmitted between the pixels on each step of signal expansion.

As this procedure is completed, each pixel in the image memorizes the number of the Sub-Texture, to which it belongs.

Procedure LB: Local Brightness of the Background

Two types of the local brightness functions Bbᵢ(z) are used. For the first type (zero order) Bbᵢ(z) is identically equal to the input brightness value Bbᵢ at the point Zᵢ. For the second type (first order) Bbᵢ(z) is equal to Lᵢ(z), where Lᵢ(z) is the linear function, such that Lᵢ(Zᵢ)=Bbᵢ and Lᵢ provides the best approximation of the input brightness values at the N nearest to Zᵢ background representing points. The choice of the type of the local brightness function is determined by the flag LBF: LBF is zero for the zero order and LBF is one for the first order of the functions Bbᵢ(z). Here N is an integer valued tuning parameter.

Typical value of N is 4 or 9: usually the background representing points form a regular or an almost regular grid, and the nearest neighbors are taken at each point Zᵢ to construct the linear function Lᵢ(z).

Procedure WB: Weights for the Background

As implied by the form of the expression, the weights WR(d(z, Zᵢ)) depend only on the distance d(z, Zᵢ) from the point z to the background representing point Zᵢ. The model function of one variable WR is specified by three tuning parameters UB1 and UB2, UB1>UB2>0, and BVS (Background Weight smoothness), 0<BVS<1, and is defined as follows:

WR(t)=0 for |t|>UB1, RGWF(t)=1 for |t|<UB2, and

WR(t)=BVS(3v²−2v³)+(1−BVS)v, for UB2<″t|<UB1,

where v=(|t|−UB2)/(UB1−UB2). See FIG. 21.

Procedure SE: Signal Expansion

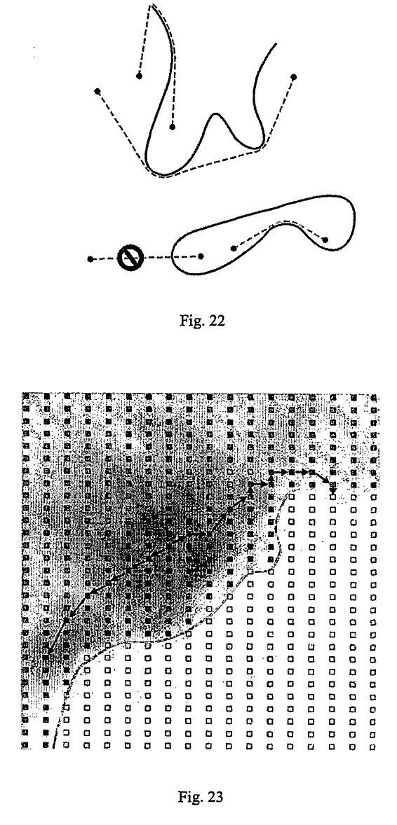

Let D denote the domain of the VIM image, with “cuts” along all the separating poly-links; PLᵢ. For any two points z₁, z₂ in D the distance dd(z₁, z₂) is defined as the (Euclidean) length of the shortest path, joining z₁ and z₂ in D and avoiding all the cuts PLᵢ. See FIG. 22, for example.

It is natural to assume that the influence of the color at z₁ to the color at z₂ decreases as the distance dd(z₁, z₂) increases. However, a precise computation of the distance dd is a rather complicated geometric problem. Consequently, we use instead of the distance dd(z₁, z₂) its approximation d(z₁, z₂), which is computed through a “signal expansion algorithm”, as described below.

The block SE computes the distance d(z₁, z₂) for any two points z₁ and z₂ in the image plane. The algorithm is not symmetric with respect to z₁ and z₂: in fact, for a fixed point z₁, the distance d(z₁, z₂) is first computed for any pixel z₂ of the image. Then an additional routine computes d(z₁, z₂) for any given z2 (and not necessarily a pixel).

Below the notion of a “neighboring pixel” is used. It is defined as follows: for z not a pixel, the four pixels at the corners of the pixel grid cell, containing z, are the neighbors of z. For z a pixel, its neighbors are all the pixels, whose coordinates in the pixel grid differ by at most one from the coordinates of z.

In the procedure below a certain data structure is organized, in which to any pixel p on the image plane a substructure is associated, allowing to mark this pixel with certain flags and to store some information, concerning this pixel, obtained in the process of computation.

Now for z₁ and z₂ given, the distance d(z₁, z₂) is computed in the following steps: For any pixel p the distance u(p) to the separating poly-links PLᵢ is computed and stored at this pixel. The computation of u(p) is performed by the procedure DL, described above, applied only to separating poly-links PLᵢ. Those pixels p, for which u(p)<FU, are marked as “forbidden” pixels. The forbidden pixels are excluded from all the rest of computations, and those pixels that are not forbidden, are called below “free” ones. Here FU is a tuning parameter.

Now the proper “signal expansion” starts. In the first step each of the free neighbor pixels of z₁ is marked, and this pixel memorizes its Euclidean distance from z₁ as the auxiliary distance dd, to be computed. Generally, in the k-th step, any free unmarked pixel p, at least one of whose free neighboring pixels was marked in the previous steps, is marked. This pixel memorizes as its auxiliary distance dd(p) from z₁, the minimum of dd at the neighboring free pixels plus one. This process is continued the number of steps, equal to the maximal dimension of the image (in pixels). After it is completed, each free pixel p on the image plane memorizes its auxiliary distance dd(p) from z₁.

For any given point z₂ on the image plane, its distance d(z₁, z₂) from z₁ is computed as maximum of D1 and D2, where D1 is the Euclidean distance of z₂ to z₁, and D2 is the minimum over the free neighboring to z₂ pixels p, of dd(p)+the Euclidean distance of z₂ to p. This optionally completes the computation of the distance d(z₁, z₂). See FIG. 23.

The tuning parameter FU optionally determines the size of a neighborhood of the separating poly-links, where all the pixels are marked as forbidden. Taking any value of FU, larger than 0.8 excludes a possibility of signal expansion crossing separating lines. Indeed, for any two neighboring pixels, which are on different sides of a separating line, at least one is closer to the line than 0.8 and hence is marked as forbidden. To provide stability of finite accuracy computations a bigger value of U may be taken. However, in this case signal expansion will not pass a “bottle-neck” between two separating lines, which are closer to one another than 2FU. Normally such regions will be covered by the cross-sections of these lines. However, a sub-pixel grid can be used to guarantee that signal expansion passes thin “bottle-necks”.

Implementation Issues.

In some embodiments of the invention, additional emphasis is put on the efficiency of the computation of the distance d(z₁, z₂) and its usage inside the background grid interpolation, so as to reduce the overall computation complexity of the image reconstruction.

In some embodiments of the invention, multi-scale implementation is used. Optionally, for reconstruction, the image is subdivided into blocks in 2-3 scales (say, blocks of 16×16, 8×8 and 4×4 pixels). In a first stage, signal expansion is performed between the highest scale blocks (say, 16×16), as described above. Forbidden are the blocks, crossed by separating characteristic lines. In the second stage the forbidden blocks are subdivided into 8×8 sub-blocks, and the expansion is performed for them. The new forbidden sub-blocks are subdivided into the 4×4 ones, and the expansion is repeated. In the last stage the expansion is completed on the pixels level.

For an application to the background grid interpolation, the distance d(z₁, z₂) is optionally computed only until the threshold UB1 is reached, since for larger distances the weight functions vanish. This restricts the number of steps in signal expansion to UB1+1.

In some embodiments of the invention, signal expansion and memorization of the distances at the free pixels can be implemented for all the background representing points at once (especially since the above distance restriction usually makes for any pixel only the information relevant, concerning a few neighboring background grid points).

Optionally, in the process of signal expansion, all the mathematical data required in the interpolation block (like Euclidean distances and weight functions) is computed incrementally, by using well known formulae for incremental computation of polynomials on grids.

Procedure MRP: Margin Representing Points

This Procedure constructs a grid of representing points on the margins of all the characteristic lines together with the background brightness values at these points. Later the constructed margin points are used (together with the original background representing points) in the interpolation process in the block BB.

The margin representing points Mzⱼ are produced in the following steps:

a. On each poly-link, the points wₖ are built with the distance UM1 from one another, starting with one of the ends (the distance is measured along the poly-link). The last constructed point on each poly-link may be closer to the end joint of this poly-link than UM1.

b. At each wₖ the line lₖ orthogonal to the poly-link and intersecting it at wₖ is drown. If wₖ turns out to be a vertex of the poly-link with a nonzero angle between the adjacent links, or a crossing, lₖ is taken to be the bissectrice of the corresponding angle.

c. On each line lₖ two points (one point in the case of the bissectrice of the crossing joint angle) are chosen at the distance UM2*W(wₖ) from the intersection point wₖ of lₖ with the poly-line (from the crossing wₖ, respectively). All the chosen points, in a certain chosen order, form the output margin representing points Mzⱼ.

d. At each margin representing point Mzⱼ constructed, the corresponding margin background brightness value Bbj is computed by Bbj=tA+(1−t)B, where A and B are the margin values (LB1 or RB1, respectively) of the cross-sections at the ends of the link S(Mzⱼ), nearest to the point Mzⱼ, and t=t(Mzⱼ). S(Mzⱼ) and t(Mzⱼ) are optionally computed by the Procedure DL.

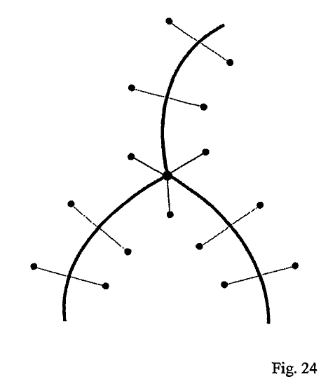

In the current Procedure, UM1 and UM2 are optionally tuning parameters (the first one absolute and the second relative to the width), satisfying UM1<UB1, 1<UM2<UL1. See FIG. 24.

Reconstruction of Depth and of Overlapping Layers

As described above, depth values are optionally stored in VIM images in the same way as each of the color components. In the reconstruction process, the depth value is optionally reconstructed for each image pixel using the same procedure, as used for reconstructing the color values of the image. The depth may be used in displaying images with layers, in order to determine how overlapping layers are to be displayed, for example using the “z-buffering” procedure, known in the art.

In an embodiment of the invention the following operations are performed in reconstruction of a multi-layer VIM image:

1. Color values and depth values are reconstructed for each layer separately (as described above) at each pixel of the bounding rectangle of the layer. Pixels outside the layer are marked accordingly.

2. A buffer is created for the entire image. In this buffer for each pixel its color and depth values, obtained from each of the layers, are stored.

3. At each pixel of the buffer the smallest depth of the layers is chosen (i.e. the layer, nearest to the viewer).

4. At each pixel the color, corresponding to the chosen (nearest to the viewer) layer is preserved to form the final image.

In order to improve efficiency of this procedure, depth sorting can be performed successively for each layer, in the process of computing the color and the depth values of this layer.

VIM Animation

In an exemplary embodiment of the invention, animation of VIM images is provided by any evolution in time of the parameters of VIM/CORE elements. Since CORE representation faithfully captures any image, and behaves consistently in video-sequences, usually a proper evolution in time of the parameters of VIM/CORE elements, with only eventual replacing of these elements, allows for faithfully representing video-sequences.

In some embodiments of the invention, any of the geometric and brightness parameters of the CORE images may evolve with time independently of the others. Alternatively, in order to reduce the number of parameters for which the existence of a change is indicated only a sub-group of parameters may change. Further alternatively or additionally, change values for a first group of parameters is specified for each image, while the change values of a second group of parameters are specified only when necessary. Optionally, the change parameters are specified relative to the previous base image. Alternatively, the change values are specified relative to the previous image.

In an exemplary embodiment of the invention, change values are specified for the following parameters: Rigid motion of the VIM Objects of the image in 3D space, Color transformations for each Layer of the image, Mutual motion of Layers in a VIM Object and Deformation of Layers in a VIM Object. In some embodiments of the invention, the mutual motion of layers and/or the deformation of layers are defined via the Skeleton Motion, as described below.

In some embodiments of the invention, the animation process is performed as follows:

A given image or a sequence of images are transformed into CORE format by a CORE transformation, as described in U.S. patent applications Ser. Nos. 09/716,279 and/or 09/902,643. Optionally, initial image analysis and/or detection of edges and ridges are performed as described in U.S. provisional patent application 60/379,415. Alternatively or additionally, a CORE image is created synthetically, for example using a graphical editing tool.

Optionally, the layers of the VIM image are defined by a user who manually marks the contours of each layer. Alternatively or additionally, an automatic layer identification procedure identifies layers, for example by identifying textures surrounded by closed characteristic lines. Using a three-dimensional (3D) editing tool, depth is added to the VIM Layers. VIM objects are optionally defined by a human operator as combinations of some of the created VIM Layers.

One or more VIM (or CORE) Skeletons are optionally inserted into VIM Objects. In this stage new skeletons can be created using the Skeleton IPI, as described below (or using conventional graphic editors). Library skeletons can also be inserted into new VIM Objects.

An animation scenario is optionally created, using Rigid motion of VIM Objects in 3D space, Color transformations for each Layer and/or Objects animation via their skeletons. The explicit animation is usually created for a sequence of Key-frames and further interpolated to the intermediate frames. Skeleton animations can be created using Skeleton IPI (or other graphic editing tools), or they can be taken from the skeleton animation libraries. If necessary, additional time evolution of any required VIM parameter is created.

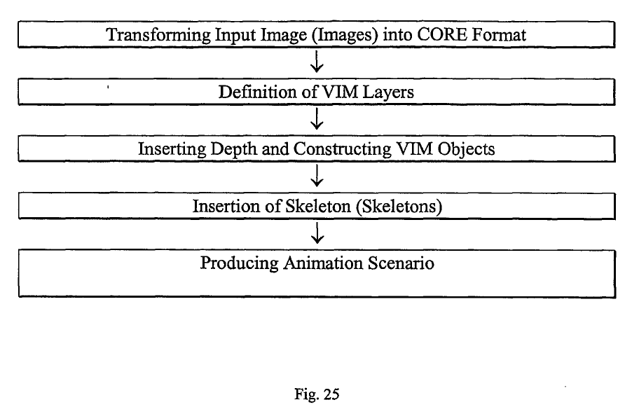

FIG. 25 represents main steps of animation creation, in accordance with an embodiment of the present invention.

CORE, VIM and R-Skeletons

A skeleton is a symbolic simplified representation of an object, allowing for an easy and intuitive control of its motion. In some embodiments of the invention, the skeleton is formed partially or entirely from characteristic lines of the object. Consequently, the CORE skeleton controls directly the geometry and the motion of CORE models, without creating any auxiliary geometric and/or kinematical structure.

Moreover, the CORE skeleton may be just a part of the CORE image representation: in this case some of the CORE Lines and points, while expressing color information, serve additionally as the skeleton elements. The same CORE models serve for capturing the color of the object, its geometric 2D and/or 3D shape and its kinematics. Special markers (flags) are used to specify each of these roles. This leads to a dramatic data reduction and simplification of processing.

Three types of skeleton are distinguished in the present invention:

CORE skeletons, which are basically applied to (flat) CORE objects, as they appear on the original image.

VIM skeletons, applied to three-dimensional CORE objects and to VIM objects.

R-skeletons, applied to any raster image or object.

However, in some exemplary embodiments of the invention, CORE skeletons are essentially a special case of VIM skeletons. A CORE skeleton is obtained by reducing a VIM skeleton to the image plane. In the later stages of construction of VIM objects and scenes the CORE skeleton may be embedded (together with the corresponding CORE object) into the 3D space. In this case it becomes a full-scale VIM skeleton. The R-skeleton uses the same mathematical solutions as the CORE and the VIM skeletons, but can act directly on the pixels of a raster image, as described below.

Implementation of the CORE, VIM and R-Skeletons

The VIM skeleton optionally comprises a wire-frame, a kinematical model and an influence model, as is now described. Optionally, each skeleton is associated with a Skeleton Image Processing Interface (IPI), which allows for a creation and an interactive control of a skeleton.

The Wire-Frame

The wire-frame of the VIM skeleton optionally comprises one or several connected 3D-curves, represented by splines (preferably of order 1, 2 or 3). Optionally, these curves are formed by spline segments, joining one another at the join points. Some join points on some of the skeleton components may be marked, and the relative position of certain groups of these marked points with respect to one another, may be fixed.

One of the specific implementations of the skeleton is through the Lines and Joints of the VIM, as described above. In particular, in this case skeleton curves are represented by P-splines. In this case the skeleton Lines are specified among the rest of the VIM's Lines by the special “Control Flag”.

Alternatively or additionally, to specifying for each skeleton an entire wire frame, some or all of the skeletons, in some embodiments of the invention, are specified by a plurality of joints and the frame is determined by connecting the joints with default segments. Optionally, the default segments comprise straight lines.

The Kinematical Model

A fall kinematical model allows for a free choice of the 3D position of the entire skeleton, of the 3D position of any of the (non-fixed) join (end) points of the spline segments, and the control of the parameters of the spline segments between the join (end) points. In some embodiments of the invention, to make animation easier, some of the degrees of freedom of the skeleton may be frozen in a default mode of operation (according to the kinematics of the animated object or to the anatomy of the animated character), and become available to the operator only in a special operation mode.

More generally, some degrees of freedom may be restricted partially or completely, or related to other degrees of freedom, according to the kinematics, the anatomy and the geometry of the animated character or object. In this way the (restricted) kinematical model of the skeleton is fixed. Properly constructed kinematical model of the skeleton makes animation especially easy for a nonprofessional operator, since any motion produced will look natural.

The geometric control model of the skeleton and its functioning are described below.

Skeleton IPI (Image Processing Interface)

The interactive control of the skeleton includes the control of the 3D position of the entire skeleton, of the 3D position of any of the join (end) points of the spline segments, and the control of the parameters of the spline segments between the join (end) points. The IPI for an interactive control of the skeleton can be constructed on the base of the Geometric IPI:

The Geometric IPI

The structure of the CORE image representation allows for a free access and variation of any of the geometric parameters of a characteristic line. Consequently, any operation on these parameters can be performed automatically or interactively.

The Geometric IPI can be constructed as follows. The operator indicates a certain end-point of the spline segments on the central line of a characteristic line, displayed on the screen. Then the indicated point is interactively moved into a desired position. The spline segments follow the motion of the end-point. By moving the central point of a spline segment, its curvature is controlled.

Alternatively, the central line can be represented by a Bezier spline, and the operator then controls its shape changing interactively positions of the spline control points. Well known conventional interfaces can be used in this step.

Using the Geometric IPI, the operator controls the projection of the skeleton on the screen plane. The depth of each of the join points and of the spline segments can be controlled by pointing with the mouse at the join point (an interior point of the spline segments, respectively), simultaneously pressing one of the buttons, assigned as the depth control button.

Any conventional 3D interface can also be used to control the VIM skeleton.

Essentially the same Skeleton IPI allows for an interactive creation of any desired VIM skeleton. In an embodiment, the operator first draws the plane wire-frame, as seen in the screen plane. Then the fixed groups of the join points are marked and the depth is inserted. Next the operator defines the kinematical restrictions of the skeleton. Finally, the operator associates desired library animations with the constructed skeleton. New animation of this constructed skeleton can be produced.

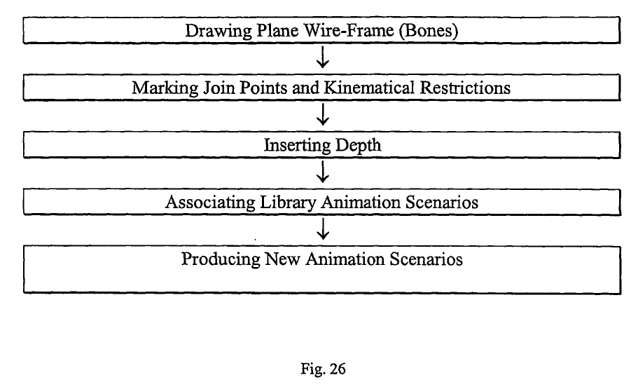

FIG. 26 shows a block-diagram, representing steps of a skeleton construction, in accordance with an embodiment of the present invention.

The Influence Model

The influence model of the VIM skeleton defines in what way the motion of the skeleton and of its parts influences the motion of the entire VIM object and the motion and geometric transformations of each of the 3D CORE objects, from which the VIM object is constructed.

Consequently, the influence model comprises the following two parts:

1. Influence scheme, prescribing the parts of the object, influences by different parts of the skeleton.

2. Motion transfer model, prescribing the way in which the motion of the skeleton is translated into the motion of any nearby point in 3D space.

As the influence model of the VIM skeleton is fixed, the motion of the skeleton is optionally translated into the motion of the VIM object in a straightforward way:

For each 3D CORE object inside the VIM object only the motion of the part of the skeleton, prescribed by the influence scheme, is taken into account.

Each control point of the splines, forming the central lines of the characteristic lines in the CORE object (in particular, the join points and the middle points in the case of parabolic splines), is transformed according to the motion transfer model. This transformation includes the depth, associated to this control point.

Each control point of the splines, forming the cross-sections of the characteristic lines in the CORE object, is transformed according to the motion transfer model. This transformation includes the depth, associated to this control point.

The grid-points of the slow-scale background, as well as geometric parameters of patches and textures are transformed in the same way.

The brightness parameters of the CORE models remain unchanged.

The Influence Scheme

This scheme associates to each 3D object inside the animated VIM object a certain part of the skeleton (usually consisting of some of the skeleton components). Only this part influences the motion of this CORE object. In a specific implementation, described above, the influence scheme of the skeleton is based on the specification of the Layers (Sub-Textures), affected by each part of the skeleton.

Motion Transfer Model

The functioning of the skeleton is optionally based on the fact that its motion is translated into the motion of the nearby points, in particular, the motion of the nearby CORE models. The present invention utilizes the following general scheme to transfer the skeleton motion to the nearby points:

The coordinate frame is constructed, comprising coordinate systems around each skeleton component.

The influence region of each skeleton component is defined.

These coordinate systems and influence regions follow the motion of the skeleton.

Now to define a motion of a certain point p in 3D space, corresponding to a given motion of the skeleton, the following steps are performed:

If the point p does not belong to any of the influence regions, it does not move.

If p belongs to a certain influence region, its coordinates with respect to the corresponding skeleton component are computed.

A new point p′ is found, whose coordinates with respect to the transformed skeleton component are the same, as the coordinates of p with respect to the S original component.

If p belongs to the only one influence region, p′ is the result of the desired motion of p.

If p belongs to several influence regions, the result of its motion is obtained by averaging the points p′, obtained with each of the influence regions involved. The averaging weights can be taken to be inverse proportional to the distances of p to the corresponding components.

Other algorithmic implementations of the motion transfer models of the skeleton are possible, for example, the one used in MPEG-4: each “bone” has its geometric influence zone, and to each point a weight is associated, reflecting the influence of each bone. The actual motion of the point is a weighted average of the bone's motions.

The Coordinate Frame

The coordinate frame of the VIM skeleton optionally comprises special coordinate systems, associated to each of the skeleton components, and of the “influence regions” of these components. In an embodiment of the present invention, the following coordinate system (u,t,w) is associated to each component of the skeleton: for any point p in the 3D space, u is the distance of this point from the considered skeleton component. The t coordinate of p is defined as the coordinate of the projection of the point p onto this component (i.e. the distance, along the component, of the projection of p from one of the end points). In turn, the w coordinate of p is defined as the rotation angle of the vector, joining the point p with its projection on the component, and the reference direction at the projection point.

The reference direction is mostly chosen to be the same at any point of the component (for example, the orthogonal direction to the component in the image plane). However, interactive choice of the reference directions at the join points and their interpolation along the component are also allowed.

The coordinate systems (u,t,w), as defined above, naturally “follow” any evolution of the skeleton components and of the entire skeleton. The new coordinates (u′,t′,w′) for a point s in 3D space are defined by the same expressions as above: u′ is the distance of the point s from the transformed skeleton component. The t′ coordinate is the coordinate of the projection of s onto the transformed component (i.e. the distance, along the component, of the projection of s from one of the end points). In turn, the w′ coordinate of s is defined as the rotation angle of the vector, joining the point s with its projection on the transformed component, and the reference direction at the projection point.

The evolution of the reference direction, following the prescribed evolution of the skeleton, can be defined as follows. In some embodiments of the invention, for rigid transformations of the entire skeleton, the reference direction is transformed exactly in the same way, while for restricted motions of the parts of the skeleton, the reference direction is kept unchanged. However, if the parts motions involve relatively strong 3D rotations, the reference directions at the join points follow these rotations.

The construction of the coordinate frame of a VIM skeleton involves an algorithmic problem that should be addressed in an implementation. The problem is that if a skeleton component has a complicated geometric shape, and if the point p is relatively far away from this component, the projection of p on the component (and hence the distance u, the coordinate t and the rotation angle w) are not uniquely defined. This non-uniqueness, in turn, leads to numerical instability of the relevant computations.

This problem is optionally settled as follows:

1. As defined above, only the points, belonging to the influence regions, are actually displaced. In implementations, these regions are taken small enough to provide uniqueness in the above algorithm.

2. The allowed motions of the skeleton in its kinematical model are restricted in such a way that too complicated or unstable shapes cannot be produced.

The Influence Regions

Normally, the influence regions of the skeleton components consist of all the points in 3D space, that are closer to this component than a certain threshold S. The threshold S is optionally chosen according to the actual shape of the object to be animated. The operator can define more complicated influence regions interactively, using Geometric IPI's or any conventional 3D editor. More complicated shapes of the influence region can be chosen, for example, those used in MPEG-4 Human animation.

The CORE Skeleton

The CORE skeleton is a special case of the VIM skeleton. Its only distinction is that it is restricted to the image plane. Hence it can be applied to any CORE object, without transforming it to a 3D CORE object. All the description above remains valid, with appropriate simplifications. In other embodiments of the invention, the skeleton is allowed a 3D existence.

Specific Scheme for Motion Transfer

For any motion of the skeleton the corresponding motion of the VIM Character is defined by the following rule:

For each point of the VIM Character the nearest component of the skeleton is pre-computed, as well as the coordinates (u,v,t) with respect to this nearest component.

The new position of the point is determined by the requirement that its coordinates (u′,v′,t′) with respect to the transformed skeleton component be the same as the initial coordinates (u,v,t).

The case of CORE skeleton is obtained by a reduction to 2D. Since mostly the contours of the VIM Characters are flat (or almost flat), the reduced coordinate system (u,v) can be used in the plane of each contour, to simplify computations. A detailed description of the coordinates, associated to the skeleton components is given above, in the Procedure DDL: distance to the Link.

Skeleton Key-Frames and Scenario

CORE and VIM skeletons provide a flexible and convenient tool to create a desired motion of the CORE (VIM) object, in accordance with an exemplary embodiment of the invention. The user optionally creates a desired evolution in time of the skeleton, and the object follows this evolution.

In some embodiments of the invention, usually, only a sequence of key-frame positions of the skeleton must be created, while the intermediate skeleton positions are obtained by interpolation. The motion scenario is a sequence of the skeleton parameters, corresponding the chosen key-frame positions.

An important issue is a choice of the skeleton parameters to be memorized in the scenario. A straightforward one is to use the coordinates of the join and end points of spline segments and the interior parameters of the spline segments. While simple and computationally inexpensive, this set of parameters has a serious drawback: it is not invariant with respect to 3D motions of the entire object or with respect to its resealing. As a result, the motion scenario has to be recomputed, as the user changes the scale of the object or the global motion direction.

Usually more convenient choice of the skeleton parameters is presented by the interior parameters of the spline segments and the rotation parameters of one spline segment with respect to another at their join points. If only flat rotations are allowed by the kinematical model (as for CORE skeletons), rotation angle at each join point is sufficient. If general 3D rotations are incorporated (as may appear in a general VIM skeleton), these rotations are parameterized by elements of the group O(3) of 3×3 orthogonal matrices, defined in the MPEG-4 standard. Alternatively or additionally, Quaternion parameters, as discussed in MPEG-4 standard, are used instead of elements of the O(3) group.

The motion scenarios, represented in this invariant form (i.e. with rotation angles and/or matrices, can be used without any modification for any rescaled and spatially displaced object.

The interpolation of the VIM (CORE) skeleton parameters can be implemented in various forms. One convenient way includes a linear interpolation of the positions of the join and end points of spline segments and of the interior spline segments parameters. Higher order interpolation, taking into account more than two nearest neighbor key-frames, can be performed.

However, the choice of the kinematical model and of the scenario parameters can prescribe another type of interpolation. For example, in an exemplary embodiment of the invention, interpolation of the rotation parameters described above, must be performed inside the group O(3) of 3×3 orthogonal matrices, to preserve the visual integrity of the rigid parts of the animated object. Such an interpolation can be performed along geodesics in the group O(3). Also here higher order interpolation can be applied to preserve a natural and smooth character of the motion.

In the case of a plane CORE skeleton, the rotation angles and the interior spline segment parameters are interpolated between the key frame positions.

R-Skeleton

R-skeleton is mathematically identical to the VIM skeleton. However, it can be applied to raster images and their Layers. This is optionally done by applying the above given formulae to each pixel of the Layer, associated to the corresponding part of the skeleton. Thus, a nonlinear “warping” is performed over some or all the pixels of the Layer. This potentially allows one to reproduce in a rather accurate way the most complicated skeleton motions.

An alternative way to impose the skeleton motion onto the Layer pixels is to translate it into a certain kind of mathematical plane transformations: projective, bilinear, affine, or rigid movements and resealing. This implementation is computationally simpler, but it introduces a mathematical rigidity into the possible layer motions. In some embodiments of the invention, in this alternative, a Character is subdivided into smaller Layers, whose, for example, affine motions reconstruct with a sufficient accuracy the original skeleton motion.

Bending and Stretching of Bones

Using spline segments as the “bones” of the VIM skeleton allows the possibility of stretching and/or bending each bone separately. In some embodiments of the invention, each of some or all of the bones of the skeleton has the following three additional parameters:

Bone Stretching “a”

Bone Bending amplitude “b”

Bone Bending direction “f”

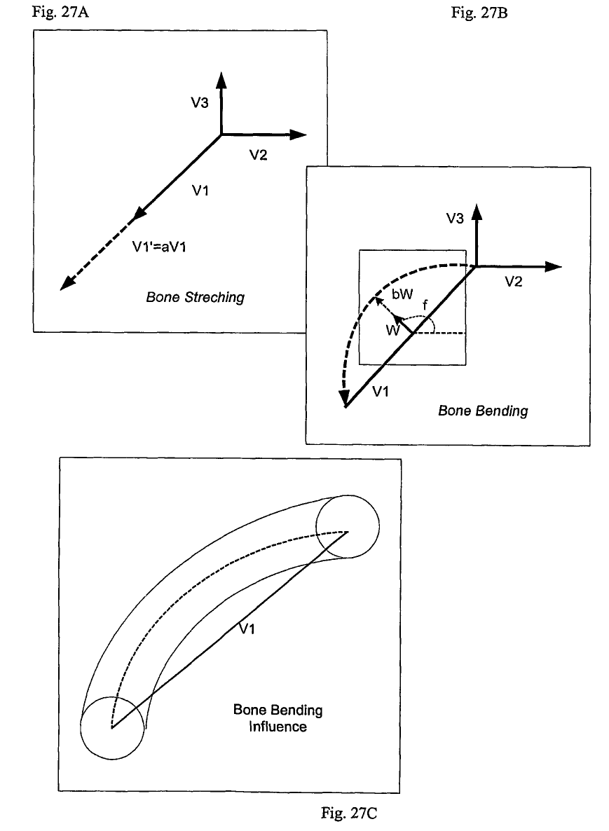

FIGS. 27A-C illustrate the geometric meaning of these parameters, in accordance with an exemplary embodiment of the invention.

In a realistic Human Body animation stretching and bending of Bones usually are not used, since in a real Human motions these effects are rather restricted. On the other hand, in less realistic artistic animations these motion patterns are common. Moreover, animator's experience shows that also in photo-realistic animations, especially those produced from a single image or from a small sample of images, additional degrees of freedom, provided by explicit stretching and bending of bones, are decisively important. Indeed, these degrees of freedom possibly allow animators to compensate for possible distortions, produced by a pose of the animated character on the original image. These animation patterns allow also for various (sometimes quite tricky) 3D and motion effects, thus producing realistic 3D motion, essentially by means of a 2D, or “2.5D” animation structure. Also in a full 3D environment completely new and important visual effects can be easily produced with the addition of stretching and bending of Bones.

On the other hand, the usage of the additional degrees of freedom, provided by explicit stretching and bending of Bones, does not generally create any additional load on the animator. Indeed, the stretching and bending of any bone may be naturally related with the Bone's position and orientation, but “uncoupled” with other Bones parameters. As a result, it can be incorporated into a simple and intuitive Animation Authoring Tool almost seamlessly. This “localization” of the stretching and bending parameters and their independence of the rest of the motion controls is especially important in a full 3D environment where coordination of the character's Skeleton 3D motion is usually a difficult animation task.

In some embodiments of the invention, instead of using a bone bending parameter, bones requiring bending are replaced by a chain of smaller Bones (at least 3-4, if a relatively smooth bending is required). However, there are some potential advantages in an explicit introducing of Bond Bending parameters:

1. The animator's work becomes much easier. Coherent interactive animation of several related bones is not an easy task, while bending one Bone can be easily produced by appropriated interactive editing tools. If a chain of Bones has to be animated to produce a bending effect, all the advantages in content creation process, mentioned above, disappear.

2. A reduction in data size is achieved. An explicit encoding of motions of several related bones, representing simple bending, requires storing and/or transmission of many parameters, while only two have a visual importance: bending direction and amplitude.

3. A reduction in computational complexity is achieved (in comparison with computations related to several connected bones). In fact the explicit formulae, given below, are almost as simple as the basic expressions without bending and stretching.

Bending and Stretching Parameters

Below the orthonormal coordinate system, related to the initial joint of the Bone, is used. V1 denotes below the Bone vector, V a vector of a generic given point, while V′ denotes the vector of this point after transformation. Stretching is defined by the stretching parameter a. For the Bone vector, V1′=a*V1. For any vector V: represent it in the coordinate system of the bone, as V=pV1+qV2+rV3, where V1 is the Bone Vector, and V2 and V3 are the unit vectors, orthogonal to the Bone. Then the new vector V′ is given by V′=a*pV1+qV2+rV3.

In other words, a times linear stretching is performed of all the space in the direction of the Bone Vector V1. Bending is defined by the bending amplitude parameter b and the bending direction parameter f. The bending direction is given by a unit vector W at the central point of the Bone, which is orthogonal to the Bone vector V1, and it is completely determined by the angle f, that W forms with the unit vector V2.

To compute the result of a bending on any vector V, representation of the vector V in the coordinate system as above is optionally used:

If V=pV1+qV2+rV3 then V′=pV1+qV2+rV3+b*p(1−p)W, for p between 0 and 1, V′=V, for p outside of the interval [0,1], i.e. for the projection of the point V on the Bone's line outside the Bone.

In the suggested formula symmetric parabolic bending of the Bone is used. Other formulae, specified by the same two parameters, can be used, for example, bending via circular segments.

As the influence of the entire Skeleton on any given point is concerned, the usual scheme is applied: the total shift is a weighted sum of the shifts, imposed by each of the Bones, with the weights defined as described in “Skin and Bones” MPEG-4 documents.

An important remark is that in some embodiments of the invention the operations of stretching and of bending commute between them. Hence they can be applied in any order, without changing the result.

However, the Bone's Rotation commutes only with stretching, but not with bending. Consequently, in each animation event the Rotation of the Bone is applied before its bending, to provide the animator an intuitive control of the bending direction.

The term brightness used above refers to both gray scale levels in black and white images and to any color components of color images, in accordance with substantially any color scheme, such as RGB. It is noted that the present invention is not limited to any specific images and may be used with substantially any images, including, for example, real life images, animated images, infra-red images, computer tomography (CT) images, radar images and synthetic images (such as appearing in Scientific visualization).

It will be appreciated that the above described methods may be varied in many ways, including, changing the order of steps, and/or performing a plurality of steps concurrently. It should also be appreciated that the above described description of methods and apparatus are to be interpreted as including apparatus for carrying out the methods and methods of using the apparatus. In particular it should be noted that an image may be stored in a format which is a composite of CORE and another format, for example, with some lines or layers being defined using a different method and/or different coordinate systems.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the limitations used in the claims. When used in the following claims, the terms “comprise”, “include”, “have” and their conjugates mean “including but not limited to”.

1. A method of representing an image, comprising:
determining one or more characteristic lines over which the profile of the image changes considerably; and
storing, for each of the one or more characteristic lines, one or more cross section profiles including data on the brightness of the line and of one or more background points adjacent the line having a brightness substantially different from the brightness of the line.

2. A method according to claim 1, wherein determining the one or more characteristic lines comprises determining a line which is different considerably from both its banks.

3. A method according to claim 1, wherein determining the one or more characteristic lines comprises determining a line which is different considerably from one of its banks.

4. A method according to claim 1, wherein storing one or more cross section profiles comprises storing, for each cross section profile, brightness values for at least three points along the cross section.

5. A method according to claim 4, wherein storing one or more cross section profiles comprises storing, for each cross section profile, brightness values for at least five points along the cross section.

6. A method according to claim 5, wherein storing one or more cross section profiles comprises storing, for each cross section profile, brightness values for at least two background points along the cross section.

7. A method according to claim 1, wherein storing one or more cross section profiles comprises storing, for each cross section profile, data on the background points, which includes at least 25% of the stored data of the profile.

8. A method according to claim 1, wherein storing data on the brightness comprises storing data on the color of the line.

9. A method according to claim 1, comprising storing brightness data on one or more points not associated with the determined lines.

10. A method of representing an image, comprising:
providing one or more characteristic lines of the image; and
classifying each of the one or more lines as belonging to one of a plurality of classes with respect to its effect on constructing background points of the image.

11. A method according to claim 10, wherein classifying the lines comprises stating a separation level.

12. A method according to claim 10, wherein classifying the lines comprises classifying into one of two classes.

13. A method according to claim 12, wherein the two classes comprise separating lines and non-separating lines.

14. A method of representing an image, comprising:
determining one or more characteristic lines over which the profile of the image changes considerably; and
storing, for at least one of the characteristic lines, a three-dimensional geometry of the line.

15. A method according to claim 14, comprising storing for the one or more characteristic lines a cross section profile.

16. A method according to claim 14, wherein storing the three-dimensional geometry comprises storing a two-dimensional geometry of the line along with at least one depth coordinate of the line.

17. A method of representing an image, comprising:
determining a characteristic line over which the brightness profile of the image changes considerably;
dividing the characteristic line into one or more segments according to the shape of the line;
selecting for each segment one of a plurality of model shapes to be used to represent the segment; and
determining, for each selected model, one or more parameter values, so that the model approximates the segment.

18. A method according to claim 17, wherein selecting the model shape comprises selecting from a group comprising an elliptic model.

19. A method according to claim 17, wherein selecting the model shape comprises selecting from a group comprising a circular model.

20. A method according to claim 17, wherein selecting the model shape comprises selecting from a group comprising a parabolic model.

21. A method according to claim 17, wherein determining the one or more parameters comprises determining end points of the segment and a maximal distance of the segment from a straight line connecting the end points.

22. A method of displaying a compressed image including a plurality of links, comprising:
determining for at least some of the pixels of the image, an associated link;
decompressing each of the links separately, without relation to the other links, so as to generate brightness values for a group of pixels in the vicinity of the link; and
selecting for the at least some of the pixels of the image a brightness value from the decompression of the associated link of the pixel.

23. A method according to claim 22, wherein determining the associated link is performed before the decompressing of the links.

24. A method according to claim 22, wherein determining the associated link is performed after the decompressing of the links.

25. A method according to claim 22, wherein determining the associated link comprises determining a nearest link.

26. A method of determining a display value of a pixel in an image represented by lines and a plurality of background points, comprising:
propagating lines from the pixel in a plurality of directions within the image;
delaying or terminating the propagating upon meeting lines of the image, according to a separation level of the line;
determining the distance to background points in the vicinity of the pixel, according to the propagating; and
calculating a brightness value for the pixel, according to the brightness values of the background points and determined distances to the background points.

27. A method according to claim 26, wherein propagating comprises propagating in a circular fashion.

28. A method of defining animation for an image, comprising:
providing a two-dimensional image;
providing a skeleton including at least one bone;
associating at least one of the bones of the skeleton with one or more portions of the image;
defining movements of the skeleton; and
moving the pixels of the portions of the image associated with moving bones of the skeleton, responsive to the movements of the bones.

29. A method according to claim 28, wherein defining movements of the skeleton comprises defining stretching of one or more bones of the skeleton.
